(19) United States
(12) Patent Application Publication
(10) Pub. No.: US 2006/0005722 A1
(43) Pub. Date: Jan. 12, 2006

(54) Misregistration when printing speed is changed, cutting misregistration, or pinter in which variation of printing density can be controlled

(76) Inventors: Satoshi Nobukawa, Hiroshima-ken (JP); Shigeo Makino, Hiroshima-ken (JP); Shinichiro Senoo, Hiroshima-ken (JP); Yoshitaka Hamamoto, Hiroshima-ken (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/507,208

(22) PCT Filed: Mar. 24, 2003
(86) PCT No.: PCT/JP03/03526

§ 371 Date: Aug. 15, 2005

(30) Foreign Application Priority Data
Mar. 25, 2002 (JP) 2002-83874
Mar. 29, 2002 (JP) 2002-97806
Mar. 29, 2002 (JP) 2002-97811

(51) Int. Cl. B41F 5/16; B41F 5/18

(52) U.S. Cl. 101/181; 101/183

(57) ABSTRACT

A fluctuation characteristic of registration between images printed by individual printing units (4A, 4B, 4C, 4D) while changing print speed is predicted for each of particular printing conditions that affect the registration fluctuation characteristic. Based on the predicted fluctuation characteristic of registration, a control characteristic of the phase between plate cylinders (5, 5, 5, 5) of the individual printing units (4A, 4B, 4C, 4D) is preliminarily set so as to compensate for vertical image misregistration between images printed by the individual printing units (4A, 4B, 4C, 4D), and is stored in a database (32). Then, when the print speed is being changed, from among the plural phase control characteristics thus preliminarily stored in the database (32), a phase control characteristic that corresponds to a printing condition concerning the current printing is selected, and the phase relation between the plate cylinders (5, 5, 5, 5) of the individual printing units (4A, 4B, 4C, 4D) is being modified according to the selected phase control characteristic. Thereby vertical image misregistration can be suppressed and the occurrence of brokes due to the change of print speed can be prevented.

### TECHNICAL FIELD

The present invention relates to control techniques concerned with change of print speed in a printing machine, and specifically, relates to a technique of controlling a multi-color rotary printing machine having plural printing units so as to suppress misregistration between images printed by the individual printing units while changing print speed, a technique of controlling a rotary printing machine having a cutting device for cutting a paper web with printed images at regular intervals into individual specified areas at a speed synchronized with print speed so as to suppress cut misregistration of the cutting device while changing print speed, and a technique of controlling a printing machine in which ink is supplied from an ink supply device via plural ink rollers to a plate cylinder so as to suppress fluctuation in print density while changing print speed.

### BACKGROUND ART

FIG. 16, FIG. 18, and FIG. 20 are schematic block diagrams each illustrating the essential part of a general offset rotary printing machine for commercial use. Additionally, FIG. 16 also shows a control system for controlling image misregistration, FIG. 18 also shows a control system for controlling cut misregistration, and FIG. 20 also shows a control system for controlling print density. As shown in each of these figures, the general commercial-use offset rotary printing machine has an in-feed section 3, a printing section 4, a dryer section 7, a cooling cylinder section 8, and a folding machine 9 as its substantial components.

The in-feed section 3 serves to pull out a paper web 2 continuously from a paper roll 1 supported by a non-illustrated reel stand, and is equipped with a non-illustrated in-feed drag for pinching the paper web 2 therebetween to transfer it rotatively, a dancer roller for controlling the tension of the paper web 2 as appropriate, and others. The in-feed drag is connected to a main shaft 13a driven by a main motor 13 so as to receive rotational driving force from the main motor 13 via the main shaft 13a.

The printing section 4 has four printing units 4A, 4B, 4C, and 4D, which are assigned to the colors black, cyan, magenta, and yellow, respectively, and arranged along the running path of the paper web 2. Each of the printing units 4A, 4B, 4C, and 4D has plural rollers including an ink-source roller 20: ink is released through a gap between the ink-source roller 20 and ink keys 19, then kneaded moderately by a series of non-illustrated ink rollers while being provided to a plate cylinder 5, and lastly transferred from the plate cylinder 5 via a blanket cylinder 6 to the paper web 2. Phase relations between the plate cylinders 5 of the individual printing units 4A, 4B, 4C, and 4D are determined in such a manner that color images of the individual printing units 4A, 4B, 4C, and 4D overlap one another within the same area on the paper web 2: the individual color images are hence laid one over another in the same area and thereby form a desired multi-color image.

After the printing section 4 has finished printing, the paper web 2 undergoes subsequent processes: drying by heat in the dryer section 7; and cooling in the cooling cylinder section 8. The dryer section 7 serves to dry ink on the paper web 2, which has just undergone printing through the printing section 4, and the cooling cylinder section 8 serves to cool down the paper web 2, which accumulates excessive heat due to the drying in the dryer section 7, to an appropriate temperature.

Downstream of the cooling cylinder section 8 provided is a compensator roll 15, whose position is adjustable by means of a compensator driving motor 16 along the directions indicated by the double-headed arrow in the diagram. The paper web 2 is wound about the compensator roll 15 in such a manner that the running length of the paper web 2 from the printing section 4 to the folding machine 9 is adjusted in accordance with the position of the compensator roll 15.

After undergoing the drying and the cooling, the paper web 2 is transferred to the folding machine 9. In the folding machine 9, the paper web 2 is folded lengthwise into two along a non-illustrated triangular board, then passed along a lead-in roller to a folder drag, and cut with a sawing cylinder and a folding cylinder into sheets of predetermined areas each corresponding to the individual images printed in the printing section 4. The cut sheets of the paper web 2 are folded up by a folding roller, a chopper folding machine, or the like into quires according to their purpose, and are carried outside as end-product printed sheets.

One of the criteria for measuring the quality of the printed sheets thus produced is whether or not their printed images are out of registration. Such image misregistration arises because, when individual color images from the printing units 4A, 4B, 4C, and 4D are printed on the paper web 2, print positions of the individual color images on the paper web 2 slightly disperse along the vertical directions of the images (the directions along the running path of the paper web 2). In the conventional rotary printing machine as mentioned above, the printing units 4A, 4B, 4C, and 4D are each connected to the main shaft 13a so as to rotate synchronously with one another due to the driving force applied from the main motor 13, and the phase relations between the plate cylinders 5 of the printing units 4A, 4B, 4C, and 4D are thereby kept constant regardless of their rotational speed. During printing, however, elongation of the paper web 2 attributed to tension fluctuation, together with fluctuation in the amount of tack (the amount of the paper web 2 pulled to the blanket cylinder 6 by cohesion of ink) and other factors, causes slight variations in running lengths of the paper web 2 between the printing units 4A, 4B, 4C, and 4D, which variations in the running lengths result in dispersion of registered positions of the individual color images along the vertical directions.

Against this backdrop, the conventional rotary printing machine is designed in such a manner that, as shown in FIG. 16, the printing units 4A, 4B, 4C, and 4D each print, separately from their object images, marks for registration purpose (register marks) in the same position on the paper web 2. The register marks of the individual colors are detected by a register-mark detecting sensor 10, which is arranged upstream of a lead-in part to the folding machine 9. Detection data of the register-mark detecting sensor 10 is transmitted to an automatic image-registration device 11. The automatic image-registration device 11 measures divergences between the detected register marks of the individual colors, more specifically, distances between the register mark of a reference color (e.g., magenta) and the register marks of the remaining colors (black, cyan, yellow) along the vertical directions. As a non-illustrated phase control motor is provided to the plate cylinder 5 of each of the printing units, with reference to the printing unit 4C, the automatic image-registration device 11 controls the phase control motor of each of the remaining printing units 4A, 4B, 4D according to the measured divergences between the detected register marks, thereby modifying the phase relations between the plate cylinder 5 of the reference printing unit 4C and the plate cylinders 5 of the remaining printing units 4A, 4B, 4D.

Another criterion for measuring the quality of printed sheets is whether or not their cut positions, at which positions the folding machine 9 has cut the paper web 2, are out of registration (cut registration) In the conventional rotary printing machine as mentioned above, the folding machine 9 is driven by the main motor 13 so as to cut the paper web 2 at a speed synchronized with the running speed (print speed) of the paper web 2. Cut timing (phase) by the folding machine 9 is determined in such a manner that when the printed paper web 2 has been cut into printed sheets, the individual multi-color image printed by the printing section 4 is located in a designated position of each of the printed sheets. During printing, however, elongation of the paper web 2 attributed to tension fluctuation, together with fluctuation in a tack amount (the amount of the paper web 2 pulled to the blanket cylinder 6 by cohesion of ink) and other factors, causes slight variation in running length of the paper web 2 from the printing section 4 toward the folding machine 9, which variation of the running length results in divergences of cut positions from their respective reference positions and, as a consequence, dispersion in print positions of images with respect to the individual printed sheets.

The conventional rotary printing machine is designed in such a manner that, as shown in FIG. 18, the printing units 4A, 4B, 4C, and 4D each print, separately from their object images, marks for registration purpose (register marks) in the same position on the paper web 2. The register marks of the individual colors are detected by the register-mark detecting sensor 10, which is arranged upstream of a lead-in part to the folding machine 9. In the conventional rotary printing machine, the register marks are not only aimed at detecting vertical image misregistration between individual color images, but also used as a cut register mark for the detection of cut misregistration. The register-mark detecting sensor 10 detects the cut register marks with detection timing, which is synchronized with the cut timing, and transmits the detection data to an automatic cut-registration device 12. Since cut registration does not require such high precision as is required by vertical image registration, the position of the cut register mark has only to be recognized roughly as the whole position of the overlapping register marks of four colors. The automatic cut-registration device 12 measures a divergence of the detected cut register mark from a reference position: a hypothetical position at which, if no cut misregistration occurs, the cut register mark is placed when the detection is carried out with the detection timing. The automatic cut-registration device 12 controls a compensator driving motor 16 to modify the position of the compensator roll 15 according to the detected divergence of the cut register mark from the reference position, thereby modifying the running length of the paper web 2 from the printing section 4 toward the folding machine 9.

Still another criterion for measuring the quality of printed sheets is the print density of printed sheets. The print density depends on the relation between the amount of ink supply and the amount of ink consumption: the lower the print density, the smaller the ink supply relative to ink consumption; the higher the print density, the larger the ink supply relative to ink consumption. Consequently, in order to obtain printed sheets of a desired print density, it is necessary to always maintain the balance between the ink consumption and the ink supply.

Against this backdrop, the conventional rotary printing machine is equipped with an ink-supply control device 14 as shown in FIG. 20, thereby controlling the rotational speed of the ink-source roller 20 according to the print speed. Specifically, the ink-supply control device 14 preliminarily stores therein a map 17 (speed function map), which indicates the rotational speed of the ink-source roller 20 in relation to the print speed as shown in FIG. 22, so as to control an ink-source motor 21, which drives the ink-source roller 20, using the speed function map 17. Information about the print speed can be obtained from a print-speed control device 25 controlling the main motor 13. Since the ink consumption varies according to the print speed while the ink supply varies according to the rotational speed of the ink-source roller 20, it is always possible to balance the ink supply with the ink consumption without variation regardless of the print speed by controlling the ink-source motor 21 using the speed function map 17.

The above-described ink supply control using the speed function map, incidentally, is not limited to a rotary printing machine of the shaft-driven type, but is common to a rotary printing machine of the shaftless type, which is equipped with a driving motor for each printing unit, and also to rotary printing machines of other types such as a sheet-fed printing machine.

Meanwhile, at the beginning of the operation of a rotary printing machine, adjustments such as the replacement of press plates are generally carried out, during which adjustments the printing machine is operated at an adjustment speed lower than a commercial-operation speed. Upon completion of the adjustments, the print speed is accelerated linearly from the adjustment speed to the commercial-operation speed, as shown in each graph (a) of FIG. 17, FIG. 19, and FIG. 21. Supplementarily, in a rotary printing machine of the so-called shaft-driven type as shown in FIG. 16, the print speed is changeable through the control of the rotational speed of the main motor 13 by the print-speed control device 25.

Since the tension fluctuation and the fluctuation in the tack amount, both described above, become so large during the acceleration of the print speed, the amounts of misregistration between the register mark of the reference color (magenta) and the register marks of the remaining colors (black, cyan, yellow) linearly increase in proportion to the acceleration as shown in graph (b) of FIG. 17, which graph indicates the case where the print color of the printing unit 4A is black, the print color of the printing unit 4B is cyan, the print color of the printing unit 4C is magenta, and the print color of the printing unit 4D is yellow. In this situation, the automatic image-registration device 11 controls the phase control motor of each of the printing units 4A, 4B, 4C, and 4D in the direction that compensates for the misregistration of register marks, thereby trying to modify the phase relation between the plate cylinders 5.

During the acceleration, however, the conventional rotary printing machine, although equipped with the automatic image-registration device 11, sometimes produces printed sheets that develop vertical image misregistration beyond a permissible range. Such considerable misregistration occurs even though the phase control motor has adequate responsive performance in itself, because the automatic image-registration device 11 is feedback controlled according to a control time constant configured at a relatively large value due to the necessity of preventing hunting. More specifically, when vertical image misregistration occurs during the acceleration, the images disperse vertically with one another at such high speed that the automatic image-registration device 11 can hardly keep up with the dispersion through the feedback control due to its control time constant. Consequently, as shown in graph (b) of FIG. 17, the vertical image misregistration goes far beyond the permissible range before the automatic registration control by the automatic image-registration device 11 takes effect.

It is therefore difficult for the conventional rotary printing machine to effectively suppress such vertical image misregistration during the acceleration of the print speed. As a result, as shown in FIG. 22, the printed sheets produced by the conventional rotary printing machine during the acceleration can hardly attain the quality required of “acceptable sheets”, which can be sold as commercial products, and therefore have to be treated as “broke” and be disposed of. Moreover, because the image misregistration that occurs during the acceleration tends to increase markedly, a considerable period of time is needed even after the print speed has reached the commercial-operation speed until the image misregistration settles back within the permissible range, so that printed sheets produced during such a time period hence have to be treated as “broke”.

Further, if the automatic cut-registration device 12 is not working during the acceleration, the cut misregistration increases linearly proportionally to the acceleration, as shown in graph (b) of FIG. 19. When working, by contrast, the automatic cut-registration device 12 controls the compensator driving motor 16 in the direction that compensates for the cut misregistration, thereby trying to adjust the position of the compensator roll 15.

During the acceleration, however, the conventional rotary printing machine, although equipped with the automatic cut-registration device 12, sometimes produces printed sheets that develop cut misregistration beyond a permissible range. Such considerable cut misregistration occurs even though the compensator driving motor 16 has adequate responsive performance in itself, because the automatic cut-registration device 12 is feedback controlled according to a control time constant configured at a relatively large value due to the necessity of preventing hunting. More specifically, when cut misregistration occurs during the acceleration, cut positions diverge at such high speed that the automatic cut-registration device 12 can hardly keep up with the divergence through the feedback control due to its control time constant. Consequently, as shown in graph (b) of FIG. 19, the amount of cut misregistration goes beyond the permissible range.

It is therefore difficult for the conventional rotary printing machine to effectively suppress such cut misregistration during the acceleration of the print speed. As a result, as shown in FIG. 22, the printed sheets produced by the conventional rotary printing machine during the acceleration can hardly attain the quality required of “acceptable sheets”, which can be sold as commercial products, and therefore have to be treated as “broke”, and be disposed of. Moreover, because the cut misregistration that occurs during the acceleration tends to increase markedly, a considerable period of time is needed even after the print speed has reached the commercial-operation speed until the amount of cut misregistration settles back within the permissible range, so that printed sheets produced during such a time period hence have to be treated as “broke”.

Still further, in order to adjust the rotational speed of the ink-source roller 20 to an appropriate value according to the print speed during the acceleration, the ink-supply control device 14 controls the ink-source motor 21, in response to a print speed signal from the print-speed control device 25, using the speed function map 17 so as to increase the rotational speed of the ink-source roller 20.

During the acceleration, however, the conventional printing machine, although thus controlling the ink-source motor 21 according to the speed function map 17, sometimes produces printed sheets on which print density declines below a permissible limit as shown in graph (b) of FIG. 21. This considerable decline occurs because a number of ink rollers intervene between the ink-source roller 20 and the plate cylinder 5, bringing about a considerable delay time before change in the rotational speed of the ink-source roller 20 is reflected in the density of ink transferred to the paper web 2. In addition, the state of decline in print density during the acceleration varies also according to an image area ratio: as shown in graph (b) of FIG. 21, the smaller the image area ratio, the more slowly the speed of the print density declines and recovers, staying outside the permissible range accordingly for a longer period of time. The main reason is as follows: the density of ink transferred from the blanket cylinder 6 to the paper web 2 varies more largely in proportion to the ink consumption, while the ink consumption is proportional to the image area ratio. Consequently, as the image area ratio is smaller, the ink consumption becomes lower, and the ink density varies more slowly.

It is therefore difficult for the conventional rotary printing machine to effectively suppress such a decline in the print density during the acceleration of the print speed. As a result, as shown in FIG. 22, the printed sheets produced by the conventional rotary printing machine during the acceleration can hardly attain the quality required of “acceptable sheets”, which can be sold as commercial products, and therefore have to be treated as “broke”, and be disposed of. Moreover, because the fluctuation in print density that occurs during the acceleration tends to increase markedly, a considerable period of time is needed even after the printing machine has reached the commercial-operation speed until the print density recovers to above the permissible limit of variation, so that printed sheets produced during such a time period hence have to be treated as “broke”.

With the foregoing problems in view, it is a first object of the invention to provide an image-registration control technique of a printing machine for suppressing fluctuation in vertical image registration while changing print speed, thereby preventing the occurrence of broke due to the change of print speed.

It is a second object of the invention to provide a cut-registration control technique of a printing machine for suppressing fluctuation in cut registration while changing print speed, thereby preventing the occurrence of broke due to the change of print speed.

It is a third object of the invention to provide a print-density control technique of a printing machine for suppressing fluctuation in print density while changing print speed, thereby preventing the occurrence of broke due to the change of print speed.

### DISCLOSURE OF THE INVENTION

In a rotary printing machine having plural printing units, when any vertical image misregistration may occur between images printed by the individual printing units while changing print speed from a first speed to a second speed different from the first speed according to a predetermined speed change characteristic, the present invention suppresses such vertical image misregistration by the following control method.

An image-registration control method of a rotary printing machine according to the present invention (first registration control method) first predicts a fluctuation characteristic of registration between images printed by the individual printing units in the case where the print speed is changed according to the predetermined speed change characteristic, and preliminarily sets a control characteristic of the phase between plate cylinders of the individual printing units based on the predicted registration fluctuation characteristic so as to compensate for vertical image misregistration between images printed by the individual printing units. Then, when the print speed is being changed, the method continuously modifies phase relation between the plate cylinders of the printing units according to the phase control characteristic thus preliminarily set. With this arrangement, since the phase relation between the plate cylinders of the printing units is modified according to the phase control characteristic preliminarily set based on the registration fluctuation characteristic in speed change, it is possible to suppress vertical image misregistration in advance, thereby preventing the occurrence of broke due to the change of print speed.

Another image-registration control method of a rotary printing machine according to the present invention (second registration control method) first predicts a fluctuation characteristic of registration between images printed by the individual printing units in the case where the print speed is changed according to the predetermined speed change characteristic for each of plural particular printing conditions that affect the registration fluctuation characteristic respectively, and preliminarily sets a control characteristic of the phase between plate cylinders of the individual printing units so as to compensate for vertical image misregistration between images printed by the individual printing units based on each of the plural registration fluctuation characteristic thus predicted. Then, when the print speed is being changed, from among the plural phase control characteristics thus preliminarily set, the method selects a phase control characteristic that corresponds to a printing condition concerning the current printing, and continuously modifies the phase relation between the plate cylinders of the printing units according to the selected phase control characteristic. With this arrangement, since the phase control characteristics are set respectively for the plural particular printing conditions that affect the registration fluctuation characteristics while the phase relation between the plate cylinders of the printing units is modified according to an appropriate one of the phase control characteristics, it is possible to suppress vertical image misregistration more reliably, thereby preventing the occurrence of broke due to the change of print speed.

In the second registration control method, the particular printing conditions affecting the registration fluctuation characteristic include, for example, the type of paper and image area ratio. The reason is as follows: fluctuation in registration is chiefly due to both elongation of the paper web, which is caused by tension fluctuation during speed change; and fluctuation in the amount of tack; the amount of elongation of the paper web relative to the tension fluctuation varies depending on the type of the paper web because properties of the paper web also vary accordingly; and the tack amount varies depending on image area ratio of the paper web because the amount of ink on the surface of the paper web also varies accordingly. Incidentally, the image area ratio also can be represented briefly by, for example, the ratio of total image area for all printing units.

When there is no phase control characteristic that corresponds to the printing condition concerning the current printing among the plural phase control characteristics preliminarily set, the present control methods can estimate an appropriate phase control characteristic by the following procedure: selecting from among preset printing conditions, which correspond to the preliminarily set phase control characteristics respectively, at least two preset printing conditions close to the printing condition concerning the current printing; and, based on the phase control characteristics that correspond to the selected preset printing conditions, estimating the phase control characteristic that corresponds to the printing condition concerning the current printing. For example, when the subject printing condition concerning the current printing is related to a new type of paper, known paper types preliminarily set are classified according to their degrees of similarity to the printing condition concerning the current printing, which degrees of similarity are determined based on the presence or absence of a coat layer. From the paper types that are classified under the same category (a coated paper group or an uncoated paper group) as the new paper, at least two other paper types are selected, and the phase control characteristic corresponding to the unset printing condition related to the new paper type is interpolated based on the phase control characteristics corresponding to the selected paper types.

In the first and second registration control methods, while modifying the phase relation between plate cylinders of the printing units according to the phase control characteristic when the print speed is being changed, it is preferable to detect misregistration between images printed by the individual printing units, and to automatically modify the phase relation between plate cylinders so as to compensate for the detected misregistration. With this arrangement, since the phase relation between plate cylinders of the printing units is changed according to the phase control characteristic, which has been set based on the registration fluctuation characteristic, while when any misregistration occurs, the phase relation between plate cylinders is automatically modified so as to compensate for the misregistration, it is possible to suppress vertical image misregistration more effectively.

The present invention is applicable regardless of whether the change of the print speed from the first speed to the second speed is acceleration or deceleration, and also applicable regardless of whether the change is a linear speed change or a complicated-pattern speed change. Especially in the case of a linear speed change at a constant rate proportional to time, since the image registration is expected to change also at a constant rate proportional to time, it is possible to estimate the rate of registration change per time for each of the printing units as a registration fluctuation characteristic. In this case, the phase control characteristic between the plate cylinders of the printing units is preferably set at such a value that the phase changes at a constant rate proportional to time. Specifically, the phase control characteristic in this case can be obtained as follows: automatically modifying the phase relation of the plate cylinders according to the misregistration between images printed by the individual printing units while changing the print speed; and, when the misregistration has settled within a permissible range by the automatic modification on completion of the speed change, calculating a phase control characteristic corresponding to the printing condition concerning the current printing based on both the phase of the plate cylinders of the printing units before the beginning of the speed change and the phase of the plate cylinders of the printing units after the end of the speed change.

The present invention also provides a rotary printing machine capable of carrying out the above registration control methods.

Specifically, a rotary printing machine according to the present invention has: plural printing units each for carrying out printing in the same area on a paper web; and print-speed control means for controlling the print speed; and is characterized in that it further has storage means and predictive registration modification means. In this rotary printing machine according to the present invention, the print-speed control means serves the function of changing print speed from a first speed to a second speed, which is different from the first speed, according to a predetermined speed change characteristic. Besides, a fluctuation characteristic of registration between the printed images of the printing units is predicted regarding the case where the print speed is changed according to the predetermined speed change characteristic. Based on the predicted registration fluctuation characteristic, a control characteristic of the phase between plate cylinders of the printing units so as to compensate for misregistration between printed images of the printing unit is preliminarily set and stored in the storage means. Especially when the print-speed control means changes the print speed from the first speed to the second speed at a constant rate proportional to time, it is also preferable to estimate the rate of change in registration per time for each of the printing units as the registration fluctuation characteristic, and to store the rate of phase change of the plate cylinder per time that corresponds to the rate of registration change. In addition, the predictive registration modification means serves the function of continuously modifying the phase relation between plate cylinders of the printing units according to the phase control characteristic stored in the storage means while the print speed is being changed by the print-speed control means. With the rotary printing machine thus arranged, it is possible to carry out the first image-registration control method.

Further, another rotary printing machine according to the present invention has: plural printing units each for carrying out printing in the same area on a paper web; and print-speed control means for controlling the print speed; and is characterized in that it further has a database, input means, and predictive registration modification means. In this rotary printing machine according to the present invention, the print-speed control means serves the function of changing the print speed from a first speed to a second speed, which is different from the first speed, according to a predetermined speed change characteristic. Besides, a fluctuation characteristic of registration between the printed images of the printing units is predicted regarding the case where the print speed is changed according to the speed change characteristic, for each of plural particular printing conditions that affect the registration fluctuation characteristic. Based on each of the plural registration fluctuation characteristic thus predicted, a control characteristic of the phase between plate cylinders of the printing units so as to compensate for misregistration between printed images of the printing units is preliminarily set and stored in the database. Especially when the print-speed control means changes the print speed from the first speed to the second speed at a constant rate proportional to time, it is also preferable to estimate the rate of change in registration per time for each of the printing units as the registration fluctuation characteristic, and to store the rate of phase change of plate cylinders per time corresponding to the rate of registration change. In addition, the predictive registration modification means serves the function of selecting from among the plural phase control characteristics stored in the database a phase control characteristic that corresponds to a printing condition inputted via the input means, and continuously modifying the phase relation between the plate cylinders of the printing units according to the selected phase control characteristic while the print speed is being changed by the print-speed control means. With the rotary printing machine thus arranged, it is possible to carry out the second registration control method.

It is also preferable that each of the above rotary printing machines further has automatic registration modification means, which serves to detect misregistration between images printed by the individual printing units and to automatically modify the phase relation of the plate cylinders so as to compensate for the detected misregistration.

Further, in a rotary printing machine having: a printing device for printing images on a running continuous paper web at regular intervals; and a cutting device for cutting the paper web into predetermined areas including the individual images, respectively, at a speed synchronized with print speed; when any cut misregistration of the cutting device may occur during changing the print speed from a first speed to a second speed different from the first speed according to a predetermined speed change characteristic, the present invention suppresses such cut misregistration by the following control method.

A cut-registration control method of a rotary printing machine according to the present invention (first cut-registration control method) first predicts a fluctuation characteristic of cut registration of cut positions by the cutting device with respect to reference positions in the case where the print speed is changed according to the predetermined speed change characteristic and, based on the predicted cut-registration fluctuation characteristic, preliminarily sets a control characteristic for the running length of the paper web from the printing device toward the cutting device so as to compensate for the cut misregistration by the cutting device. Then, when the print speed is being changed, the method continuously modifies phase relation between the plate cylinders of the printing units according to the phase control characteristic thus preliminarily set. With this arrangement, since the running length of the paper web from the printing device toward the cutting device is modified according to the running-length control characteristic preliminarily set based on the cut-registration fluctuation characteristic in speed change, it is possible to suppress cut misregistration in advance, thereby preventing the occurrence of broke due to the change of print speed.

Another cut-registration control method of a rotary printing machine according to the present invention (second cut-registration control method) first predicts a fluctuation characteristic of cut registration of cut positions by the cutting device with respect to reference positions in the case where the print speed is changed according to the predetermined speed change characteristic, for each of the plural particular printing conditions that affect the registration fluctuation characteristic, and preliminarily sets a control characteristic for the running length of the paper web from the printing device toward the cutting device so as to compensate for the cut misregistration by the cutting device based on each of the plural cut-registration fluctuation characteristics thus predicted. Then, when the print speed is being changed, from among the plural running-length control characteristics thus preliminarily set, the method selects a running-length control characteristic that corresponds to a printing condition concerning the current printing, and continuously modifies the running length according to the selected running-length control characteristic. With this arrangement, since running-length control characteristics are set respectively for plural particular printing conditions that affect the cut-registration fluctuation characteristic while the running length of the paper web from the printing device toward the cutting device is modified according to an appropriate one of the running-length control characteristics, it is possible to suppress cut misregistration more reliably, thereby preventing the occurrence of broke due to the change of print speed.

In the second cut-registration control method, the particular printing conditions affecting the cut-registration fluctuation characteristic include, for example, the paper type of the paper web and the tension of the paper web from the printing device to the cutting device. It is considered that the fluctuation in cut registration is mainly caused by fluctuation in running length of the paper web, which is chiefly due to tension fluctuation during speed change. From this main cause, it is expected that the difference of paper types and the variation in preset tension have some effect.

When there is no running-length control characteristic that corresponds to the printing condition concerning the current printing among the plural running-length control characteristics preliminarily set, the present control methods can estimate an appropriate running-length control characteristic by the following procedure: selecting from among the preset printing conditions, that correspond to the preliminarily set running-length control characteristics respectively, at least two preset printing conditions close to the printing condition concerning the current printing; and estimating the running-length control characteristic that corresponds to the printing condition concerning the current printing based on the running-length control characteristics that correspond to the selected preset printing conditions. For example, when the subject printing condition concerning the current printing is related to a new type of paper, known paper types preliminarily set are classified according to their degrees of similarity to the printing condition concerning the current printing, which degrees of similarity are determined based on the presence or absence of a coat layer. From the paper types that are classified under the same category (a coated paper group or an uncoated paper group) as the new paper, at least two other paper types are selected, and the running-length control characteristic corresponding to the unset printing conditions is interpolatively set based on the running-length control characteristics corresponding to the selected paper types.

In the first and second cut-registration control method, while modifying the running length according to the running-length control characteristic when the print speed is being changed, it is preferable to detect cut misregistration of cut positions by the cutting device with respect to reference positions, and to automatically modify the running length so as to compensate for the detected misregistration. With this arrangement, since the running length of the paper web from the printing device toward the cutting device is changed according to the running-length control characteristic, which has been set based on the cut-registration fluctuation characteristic during speed change, while when any cut misregistration occurs, the running length is automatically modified so as to compensate for the misregistration, it is possible to suppress cut misregistration more effectively.

The present invention is applicable regardless of whether the change of the print speed from the first speed to the second speed is acceleration or deceleration, and also applicable regardless of whether the change is a linear speed change or a complicated-pattern speed change. Especially in the case of a linear speed change at a constant rate proportional to time, since the cut-registration is expected to change also at a constant rate proportional to time, it is possible to estimate rate of cut registration change per time as a cut-registration fluctuation characteristic. In this case, the running-length control characteristic is preferably set at such a value that the running length changes at a constant rate proportional to time. Specifically, the running-length control characteristic in this case can be obtained as follows: automatically modifying the running length according to the cut misregistration of cut positions by the cutting device with respect to reference positions while changing the print speed; and, when the cut misregistration has settled within a permissible range due to the automatic modification on completion of the speed change, calculating a running-length control characteristic corresponding to the printing condition concerning the current printing based on both the running length (or the control parameter corresponding to the running length) before the beginning of the speed change and the running length (or the control parameter corresponding to the running length) after the end of the speed change.

The present invention also provides a rotary printing machine capable of carrying out the above cut-registration control methods.

Specifically, a rotary printing machine according to the present invention has: a printing device for printing images on a running continuous paper web at regular intervals; a cutting device for cutting the paper web into predetermined areas including the individual images, respectively, at a speed synchronized with the print speed; and print-speed control means for controlling the print speed; and is characterized in that it further has running-length modification means, storage means, and predictive cut-registration modification means. In this rotary printing machine according to the present invention, the print-speed control means serves the function of changing the print speed from a first speed to a second speed, which is different from the first speed, according to a predetermined speed change characteristic. Besides, a fluctuation characteristic of cut registration of cut positions by the cutting device with respect to reference positions is predicted regarding the case where the print speed is changed according to the speed change characteristic. Based on the predicted cut-registration fluctuation characteristic, a control characteristic of the running length so as to compensate for cut misregistration of the cutting device is preliminarily set and stored in the storage means. Especially when the print-speed control means changes the print speed from the first speed to the second speed at a constant rate proportional to time, it is also preferable to estimate the rate of change in cut registration per time as the cut-registration fluctuation characteristic, and to store the rate of change of running length per time corresponding to the rate of cut registration change per time. In addition, the predictive cut-registration modification means serves the function of continuously modifying the running length of the paper web from the printing device toward the cutting device by controlling the running-length modification means according to the running-length control characteristic stored in the storage means while the print speed is being changed by the print-speed control means. With the rotary printing machine thus arranged, it is possible to carry out the first cut-registration control method.

Further, another rotary printing machine according to the present invention has: a printing device for printing images on a running continuous paper web at regular intervals; a cutting device for cutting the paper web into predetermined areas including the individual images, respectively, at a speed synchronized with the print speed; print-speed control means for controlling the print speed; and is characterized in that it further has running-length modification means, a database, input means, and predictive cut-registration modification means. In this rotary printing machine according to the present invention, the print-speed control means serves the function of changing print speed from a first speed to a second speed, which is different from the first speed, according to a predetermined speed change characteristic. Besides, a fluctuation characteristic of cut registration of cut positions with the cutting device with respect to reference positions is predicted regarding the case where the print speed is changed according to the speed change characteristic, for each of plural particular printing conditions affecting the registration fluctuation characteristic. Based on each of the plural cut-registration fluctuation characteristics thus predicted, a control characteristic of the running length so as to compensate for cut misregistration of the cutting device is preliminarily set and stored in the database. Especially when the print-speed control means changes the print speed from the first speed to the second speed at a constant rate proportional to time, it is also preferable to estimate the rate of change in cut registration per time as the cut-registration fluctuation characteristic, and to store the rate of change of running length per time corresponding to the rate of cut registration change per time. In addition, the predictive cut-registration modification means serves the function of selecting from among the plural running-length control characteristics stored in the database a running-length control characteristic that corresponds to a printing condition inputted via the input means, and continuously modifying the running length of the paper web from the printing device toward the cutting device by controlling the running-length modification means according to the selected running-length control characteristic while the print speed is being changed by the print-speed control means. With the rotary printing machine thus arranged, it is possible to carry out the second registration control method.

It is also preferable that each of the above rotary printing machines further has automatic cut-registration modification means, which serves to detect the cut misregistration of cut positions by the cutting device with respect to reference positions, and to automatically modify the running length by controlling the running-length modification means so as to compensate for the detected misregistration.

Further, in a rotary printing machine in which ink is supplied from an ink supplying device via plural ink rollers to a plate cylinder, when fluctuation in print density occurs while changing print speed from a first speed to a second speed different from the first speed according to a predetermined speed change characteristic, the present invention suppresses such print density fluctuation by the following control method.

A print-density control method of a printing machine according to the present invention first predicts a fluctuation characteristic of print density in the case where the print speed is changed according to the predetermined speed change characteristic and, based on the predicted print-density fluctuation characteristic, preliminarily sets an ink-supply control characteristic of the ink supplying device so as to compensate for the fluctuation in print density. Then, the method controls the amount of ink supplied from the ink supplying device in accordance with the print speed during the constant-speed operation, while continuously modifying the amount of ink supplied from the ink supplying device according to the preliminarily set ink-supply control characteristic during a predetermined period from a point of time before said print-speed control means starts changing the print speed toward another point of time after the changing of the print speed ends. With this arrangement, since the amount of ink supplied from the ink supplying device is modified according to the ink-supply control characteristic preliminarily set based on the print-density fluctuation characteristic in speed change, it is possible to suppress fluctuation in print density effectively, thereby preventing the occurrence of broke due to the change of print speed.

In the above print-density control method, when the ink supplying device has: an ink-source roller, incorporated in the ink bottle, for controlling an amount of ink supply from the ink bottle in terms of the rotational speed; and plural ink keys, incorporated in the ink bottle together with the ink-source roller and arranged axially of the ink-source roller, for controlling the amount of ink supplied from the ink bottle in terms of the openness of a gap with respect to the ink-source roller; it is also preferable to control the print density by the following method.

Namely, the present method preliminarily sets a control characteristic for the rotational speed of the ink-source roller per time as the ink-supply control characteristic and, during the predetermined period, continuously modifies the rotational speed of the ink-source roller according to the rotational-speed control characteristic thus set. By modifying the rotational speed of the ink-source roller as such, it is possible to suppress fluctuation in print density uniformly along the width.

Further, it is also preferable to predict a fluctuation characteristic of print density for each of different values of image area ratio, and to set a control characteristic for the rotational speed of the ink-source roller per time for each image area ratio value based on the predicted print-density fluctuation characteristic. In this case, during the predetermined period, the method selects from among plural rotational-speed control characteristics, which have been preliminarily set, a rotational-speed control characteristic that corresponds to an average image area ratio of the printed sheets produced in the current printing, and modifies the rotational speed of the ink-source roller according to the selected rotational-speed control characteristic. Since the fluctuation in print density during speed change differs according to the image area ratio, by thus modifying the rotational speed of the ink-source roller according to the rotational-speed control characteristic preliminarily set according to the average image area ratio, it is possible to suppress fluctuation in print density more reliably.

Further, it is also preferable to predict a characteristic for the fluctuation in print density for each of different values of image area ratio and, based on the predicted print-density fluctuation characteristic, to set a control characteristic for the rotational speed of the ink-source roller per time in the case where the image area ratio value is a predetermined reference image area ratio value, and also to set a control characteristic for openness of the ink keys with respect to deviation of the image area ratio value from the reference image area ratio value. In this case, during the predetermined period, the openness of each of the ink keys is corrected according to the openness control characteristic in proportion to the distribution of the image area ratio value along the width in printed sheets produced in the current printing, while the rotational speed of the ink-source roller is modified according to the rotational-speed control characteristic. Since the image area ratio varies for each width of the ink keys, by thus modifying the rotational speed of the ink-source roller according to the rotational-speed control characteristic while correcting the openness of each ink key in proportion to the distribution of the image area ratio value along the width of printed sheets, it is possible to suppress fluctuation in print density more reliably.

Further, in the above print-density control method, it is also preferable to predict a fluctuation characteristic of print density in the case where the print speed is changed according to the speed change for each of the particular printing conditions that affect the print-density fluctuation characteristic, and to preliminarily set the ink-supply control characteristic for each printing condition. In this case, during the predetermined period, from among the plural ink-supply control characteristics thus preliminarily set, the method selects an ink-supply control characteristic that corresponds to a printing condition concerning the current printing, and modifies the amount of ink supplied from the ink supplying device according to the selected ink-supply control characteristic. With this arrangement, since the amount of ink supply is modified according to the ink-supply control characteristic, which has been set for each of the particular printing conditions affecting the print-density fluctuation characteristic during speed change, it is possible to suppress fluctuation in print density more reliably.

In the above case, the particular printing conditions affecting the print-density fluctuation characteristic include, for example, the type of paper, the kind of ink, image area ratio, and the like. Even though the ink amount is constant, the print density varies according to the type of paper and the kind of ink, and the fluctuation speed of print density also differs as the image area ratio varies. When there is no print-density fluctuation characteristic that corresponds to the printing condition concerning the current printing among the plural print-density fluctuation characteristics preliminarily set, the present control method can estimate an appropriate print-density fluctuation characteristic in the following procedure: selecting from among the preset printing conditions, which correspond to the preliminarily set print-density fluctuation characteristic respectively, at least two preset printing conditions close to the printing condition concerning the current printing; and, based on the print-density fluctuation characteristics that correspond to the selected preset printing conditions, estimating the print-density fluctuation characteristic that corresponds to the printing condition concerning the current printing. For example, when the subject printing condition concerning the current printing is related to a new type of paper, known paper types preliminarily set are classified according to their degrees of similarity to the printing condition concerning the current printing, which degrees of similarity are determined based on the presence or absence of a coat layer. From the paper types that are classified under the same category (a coated paper group or an uncoated paper group) as the new paper, at least two other paper types are selected, and the print-density fluctuation characteristic corresponding to the unset printing condition related to the new paper type is interpolated based on the print-density fluctuation characteristics corresponding to the selected paper types.

The present invention also provides a printing machine capable of carrying out the above mentioned print-density control method.

Specifically, a printing machine according to the present invention has: an ink supplying device for supplying ink; plural ink rollers for transferring the ink sequentially from the ink supplying device to a plate cylinder; and print-speed control means for controlling print speed; and is characterized in that it further has storage means in which an ink-supply control characteristic of the ink supplying device is stored. In this printing machine, the print-speed control means serves the function of changing print speed from a first speed to a second speed, which is different from the first speed, according to a predetermined speed change characteristic. Futhermore, based on a fluctuation characteristic of print density in the case where the print speed is changed according to the predetermined speed change characteristic, a control characteristic of ink-supply per time so as to compensate for the fluctuation in print density is predicted and used as the ink-supply control characteristic stored in the storage means. In addition, the ink-supply control means serves the function of controlling the amount of ink supplied from the ink supplying device according to the print speed during the constant-speed operation, while modifying the ink amount supplied from the ink supplying device according to the ink-supply control characteristic stored in the storage means during a predetermined period between a instant before the print-speed control means starts changing the print speed and another instant after the changing of the print speed ends.

Further, another printing machine according to the present invention has: an ink bottle containing ink; an ink-source roller, incorporated in the ink bottle, for controlling an amount of ink supply from the ink bottle in terms of the rotational speed; plural ink keys, incorporated in the ink bottle together with the ink-source roller and arranged axially of the ink-source roller, for controlling the amount of ink supplied from the ink bottle in terms of the openness of a gap with respect to the ink-source roller; print-speed control means for controlling the print speed; and rotational-speed control means for controlling the rotational speed of the ink-source roller; and is characterized in that it has storage means in which a control characteristic for the rotational speed of the ink-source roller is stored. In this printing machine, the print-speed control means serves the function of changing the print speed from a first speed to a second speed, which is different from the first speed, according to a predetermined speed change characteristic. Besides, based on a fluctuation characteristic of print density in the case where the print speed is changed according to the predetermined speed change characteristic, a control characteristic of the rotational speed of the ink-source roller per time so as to compensate for the fluctuation in print density when the print speed is being changed is predicted and used as the rotational-speed control characteristic stored in the storage means. In addition, the rotational-speed control means serves the function of controlling the rotational speed of the ink-source roller according to the print speed during the constant-speed operation, while modifying the rotational speed of the ink-source roller according to the rotational-speed control characteristic stored in the storage means during a predetermined period between a instant before said print-speed control means starts changing the print speed and another instant after the changing of the print speed by the print-speed control means ends.

It is also preferable that the storage means is a database in which a rotational-speed control characteristic is stored, and that the print-density fluctuation characteristic is predicted for each of different values of the image area ratio, while the rotational-speed control characteristic is set for based on the predicted print-density fluctuation characteristic. In this case, the rotational-speed control means serves the function of, during the predetermined period, selecting from among plural rotational-speed control characteristics stored in the database a rotational-speed control characteristic that corresponds to the average image area ratio value of printed sheets produced in the current printing, and modifying the rotational speed of the ink-source roller according to the selected rotational-speed control characteristic.

It is also preferable that the printing machine further has openness control means for controlling the openness of the ink keys, and that the storage means stores therein a control characteristic of the rotational speed of the ink-source roller per time in the case where the image area ratio value is a reference image area ratio value, and also stores a control characteristic of openness of the ink keys with respect to deviation of the image area rate from the reference image area rate. Both of the rotational-speed control characteristic and the openness control characteristic are preliminarily set based on the print-density fluctuation characteristic predicted for each of the different image area ratio values. In this case, the rotational-speed control means serves the function of modifying the rotational speed of the ink-source roller according to the rotational-speed control characteristic during the predetermined period, and the openness control means serves the function of correcting the openness of each of the ink keys according to the openness control characteristic in proportion to distribution of the image area ratio value along the width of printed sheets produced in the current printing during the predetermined period.

### BRIEF DESCRIPTION OF THE DRAWINGS

FIG. 1 is a schematic diagram showing the arrangement of a rotary printing machine according to the first embodiment of the present invention;

FIG. 2 is a diagram illustrating the details of image-registration control by the rotary printing machine of FIG. 1, including graph (a), which shows the relation between the amount of image registration to be modified through feedforward control (FF modification amount) and acceleration time, graph (b), which shows the relation between the amount of image registration to be modified through feedback control (FB modification amount) and acceleration time, and graph (c), which shows the relation between the total amount of image registration to be modified and acceleration time;

FIG. 3 is a diagram illustrating the details of the image-registration control by the rotary printing machine of FIG. 1 in connection with FIG. 2, including graph (a), which shows the relation between the amount of image registration to be modified through feedforward control (FF modification amount) and acceleration time when the speed of modifying image registration being varied, and graphs (b) and (c), which each show the relation between the amount of image registration to be modified through feedforward control (FF modification amount) and acceleration time when the speed of modifying image registration is constant at L1 and L2, respectively, which are both designated in graph (a);

FIG. 4 is a diagram showing the relations between image area ratio and the fluctuation amount of image registration;

FIG. 5 is a diagram showing a time chart of print speed control by the rotary printing machine of FIG. 1, FIG. 6, or FIG. 10, together with a time area within which acceptable sheets are produced;

FIG. 6 is a schematic diagram showing the arrangement of a rotary printing machine according to the second embodiment of the present invention;

FIG. 7 is a diagram illustrating the details of cut-registration control by the rotary printing machine of FIG. 6, including graph (a), which shows the relation between the amount of cut registration through feedforward control (FF modification amount) and acceleration time, graph (b), which shows the relation between the amount of cut registration through feedback control (FB modification amount) and acceleration time, and graph (c), which shows the relation between the total amount of cut registration to be modified and acceleration time.

FIG. 8 is a diagram illustrating the details of cut-registration control by the rotary printing machine of FIG. 6 in connection with FIG. 7, including graph (a), which shows the relation between the amount of cut registration to be modified through feedforward control (FF modification amount) and acceleration time when the speed of modifying the position of the compensator roll is varied, and graphs (b) and (c), which each show the amount of cut registration to be modified through feedforward control (FF modification amount) and acceleration time when the speed of modifying the position of the compensator roll is constant at L1 and L2, respectively, which are both designated in graph (a);

FIG. 9 is a diagram showing the relation between the tension of paper web and the fluctuation amount of cut registration for different types of paper;

FIG. 10 is a schematic diagram showing the arrangement of a printing machine according to the third embodiment of the present invention;

FIG. 11 is a diagram illustrating the details of print density control by the printing machine of FIG. 10, including graph (a), which shows the change of print speed from an adjustment speed to a commercial-operation speed, graph (b), which shows the change in rotational speed of the ink-source roller, and graph (c), which shows the fluctuation in print density;

FIG. 12 is a schematic diagram showing the arrangement of a printing machine according to the fourth embodiment of the present invention;

FIG. 13 is a diagram illustrating the problems to be solved by the printing machine of FIG. 12, including graph (a), which shows the change of print speed from the adjustment speed to the commercial-operation speed, graph (b), which shows the change in rotational speed of the ink-source roller, and graph (c), which shows the fluctuation in print density;

FIG. 14 is a diagram illustrating the details of print density control by the printing machine of FIG. 12, including graph (a), which shows the change of print speed from the adjustment speed to the commercial-operation speed, graph (b), which shows the change in rotational speed of the ink-source roller, and graph (c), which shows the fluctuation in print density;

FIG. 15 is a schematic diagram illustrating the arrangement of a printing machine according to the fifth embodiment of the present invention;

FIG. 16 is a diagram illustrating the arrangement of a conventional rotary printing machine, together with a control system for controlling image registration;

FIG. 17 is a diagram illustrating the problems attendant on the conventional rotary printing machine, including graph (a), which shows the change of print speed from an adjustment speed to a commercial-operation speed, and graph (b), which shows, with respect to the reference color (magenta), the fluctuation of registration of the remaining colors (black, cyan, yellow) under the conditions of graph (a);

FIG. 18 is a diagram illustrating the arrangement of the conventional rotary printing machine, together with a control system for controlling cut registration;

FIG. 19 is a diagram illustrating the problems attendant on the conventional rotary printing machine, including graph (a), which shows the change of print speed from the adjustment speed to the commercial-operation speed, and graph (b), which shows the fluctuation in cut registration under the conditions of graph (a);

FIG. 20 is a diagram illustrating the arrangement of the conventional rotary printing machine, together with a control system for controlling the print density;

FIG. 21 is a diagram illustrating the problems attendant on the conventional rotary printing machine, including graph (a), which shows the change of print speed from the adjustment speed to the commercial-operation speed, and graph (b), which shows the fluctuation in print density under the conditions of graph (a); and

FIG. 22 is a diagram showing a time chart of print speed control by the conventional rotary printing machine, together with a time area within which acceptable sheets are produced.

### BEST MODE FOR CARRYING OUT THE INVENTION

The following description will be made of the embodiments of the present invention with reference to these Figs.

### (A) First Embodiment

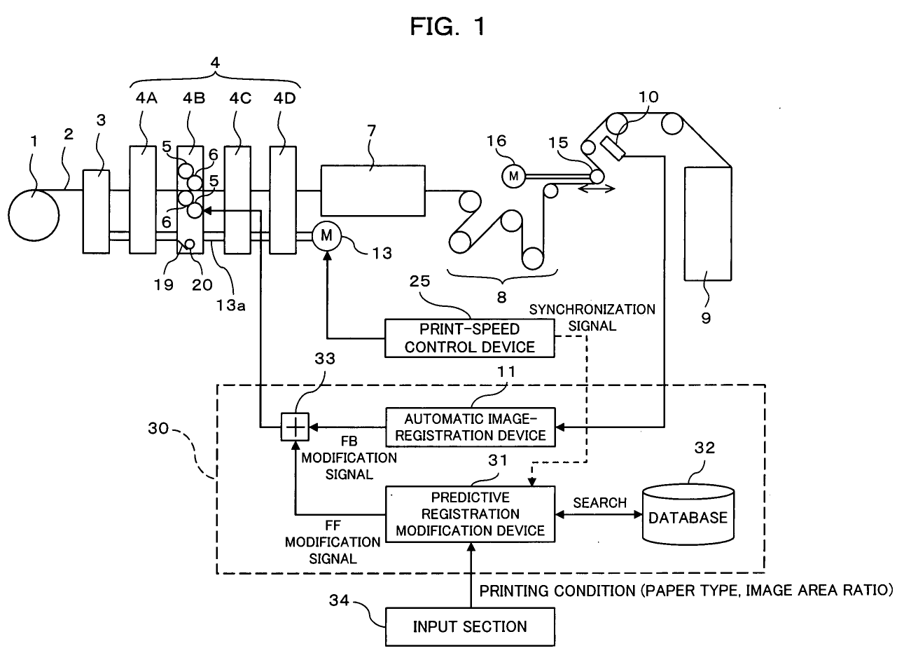

FIG. 1 is a schematic diagram showing the arrangement of a rotary printing machine according to the first embodiment of the present invention. As shown in FIG. 1, the rotary printing machine according to the present embodiment differs from the conventional rotary printing machine shown in FIG. 16 only in arrangement of the control device, being identical in arrangement of the main body of the printing machine. It is to be noted, however, that FIG. 1 is strictly for the purpose of simplifying the explanation of the nonessential part of the present invention, and does not signify that the registration control method according to the present invention is limitedly applied to the rotary printing machines with such arrangement.

The rotary printing machine according to the present embodiment has a predictive registration modification device 31 in addition to the conventional automatic image-registration device (automatic registration modification means) 11, so that the automatic image-registration device 11 and the predictive registration modification device (predictive registration modification means) 31 together compose a registration control device 30. In contrast to the automatic image-registration device 11, which modifies registration through feedback control, the predictive registration modification device 31 has the function of modifying registration through feedforward control.

The predictive registration modification device 31 carries out feedforward control specifically in the following manner. The feedforward control by the predictive registration modification device 31 is effected in response to a synchronization signal from the print-speed control device 25. The print-speed control device 25 controls the print speed through the control of the rotational speed of the main motor 13, operating as shown in FIG. 5: at the start of printing, it temporarily accelerates the print speed linearly toward an adjustment speed; at the completion of adjustment, it again accelerates the print speed from the adjustment speed toward a commercial-operation speed linearly, namely at a constant rate proportional to time; and at the completion of printing, it decelerates the print speed linearly from the commercial-operation speed toward the halt condition. In the present embodiment, a synchronization signal for starting the feedforward control is inputted from the print-speed control device 25 to the predictive registration modification device 31 at the start of the acceleration from the adjustment speed toward the commercial-operation speed, while a synchronization signal for stopping the feedforward control is inputted from the print-speed control device 25 to the predictive registration modification device 31 at the end of the acceleration.

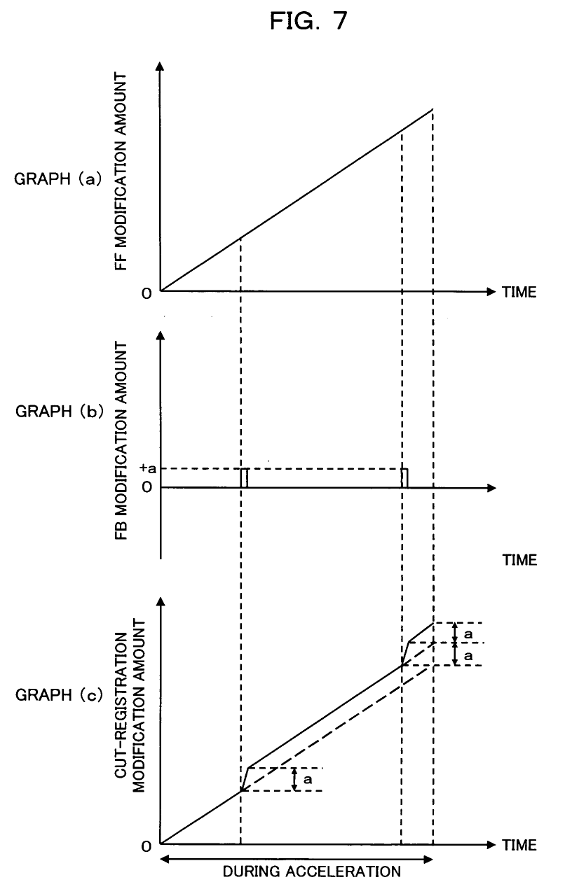

The feedforward control by the predictive registration modification device 31 acts in such a manner as to compensate for the fluctuation in vertical image registration of the images of non-reference colors (black, cyan, yellow) with respect to the image of the reference color (magenta) as shown in graph (b) of FIG. 7, by modifying the phases of the plate cylinders 5 of the printing unit 4A, 4B, and 4D, which correspond to black, cyan, and yellow respectively. When the print speed is accelerated linearly as described above, the vertical image registration also changes linearly at a constant rate of change of registration as shown in graph (b) of FIG. 7. The predictive registration modification device 31 therefore operates to change the phases of the plate cylinders 5 of the printing unit 4A, 4B, 4D (with reference to the plate cylinders 5 of the magenta printing unit 4C) linearly, namely at a constant rate proportional to time. The directions and the rates of phase change for the plate cylinders 5 are justly varied among the printing units 4A, 4B, 4D: the plate cylinders 5 of the printing units 4A and 4B, which correspond to black and cyan respectively, are phase-changed in the advancing direction of phase angle, while the rate of phase change for black (printing unit 4A) is set higher than the rate of phase change for cyan (printing unit 4B); on the other hand, the plate cylinders 5 of the printing unit 4D, which corresponds to yellow, are phase-changed in the retarding direction of phase angle. It is to be noted that although the plate cylinders 5 of the printing unit 4C of the third color is selected as the reference in the present embodiment, the plate cylinders 5 of any other printing unit 4A, 4B, 4D also can be used as the reference.

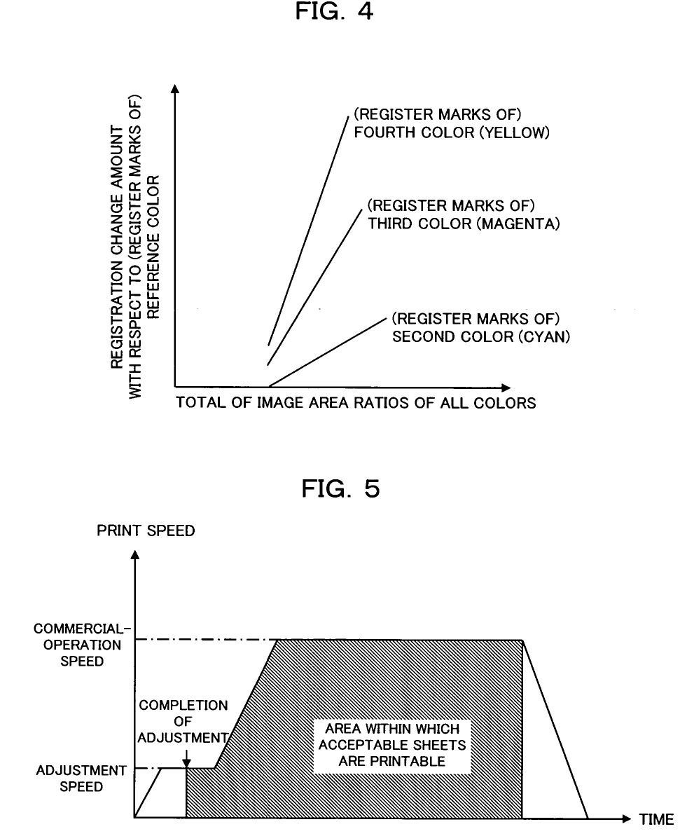

Meanwhile, through the conception process of the present invention, the inventors have found that even when the print speed is changed at the same rate of acceleration, the fluctuation characteristic of vertical image registration differs as each of certain particular printing conditions differs. Examples of such particular printing conditions are paper types and image area ratio. The difference among paper types, attended with variation in their properties, is considered to bring about variation in the amount of elongation of the paper web with respect to the tension fluctuation during acceleration, whereby the fluctuation amount of vertical image registration differs accordingly. Also the difference in image area ratio, attended with variation in the amount of ink on the surface, is considered to cause variation in the tack amount, which is the amount of the paper web 2 pulled to the blanket cylinder 6, whereby the fluctuation amount of vertical image registration differs accordingly. FIG. 4 is a diagram showing the experimental results using the first color, black, as the reference while indicating the relation between the fluctuation amount of vertical image registration (the final variation amount at the completion of the acceleration) and the image area ratio for each of the remaining colors (cyan, magenta, yellow). The image area ratio is usually calculated for each of ink-key zones along the width so as to correspond to the amount of ink supply: using the total of those data for each of the colors as a parameter, it is possible to obtain approximately linear relationship with the fluctuation amount of vertical image registration as shown in FIG. 4.

Since the fluctuation characteristic of vertical image registration thus varies as the paper type or the image area ratio varies, in order to suppress fluctuation in registration in advance through feedforward control, it is necessary to adjust the control characteristics of the phases of the plate cylinders 5 according to the paper types or the image area ratio. On this account, in the present embodiment, the registration control device 30 is equipped with a database 32 in which a phase control coefficient (phase control characteristic) is stored for each of preset paper types and for each of preset image area ratio values: the phase control coefficient means the gradient of phase change for the plate cylinder 5 of the individual printing unit 4A, 4B, 4D (the rate of phase change per time) in the case where the phase is changed in proportion to time. More specifically, the relation between the total of the image area ratio values for all colors and the variation amount of registration can be expressed as a map (or mathematical formula) as shown in FIG. 4, so that the total of the image area ratio values for all colors and the phase control coefficient also can be expressed as a map (or mathematical formula). In the database 32, the map (or mathematical formula) that expresses the relation between the total of the image area ratio values for all colors (hereinafter called as total image area ratio) and the phase control coefficient is stored for each paper type.

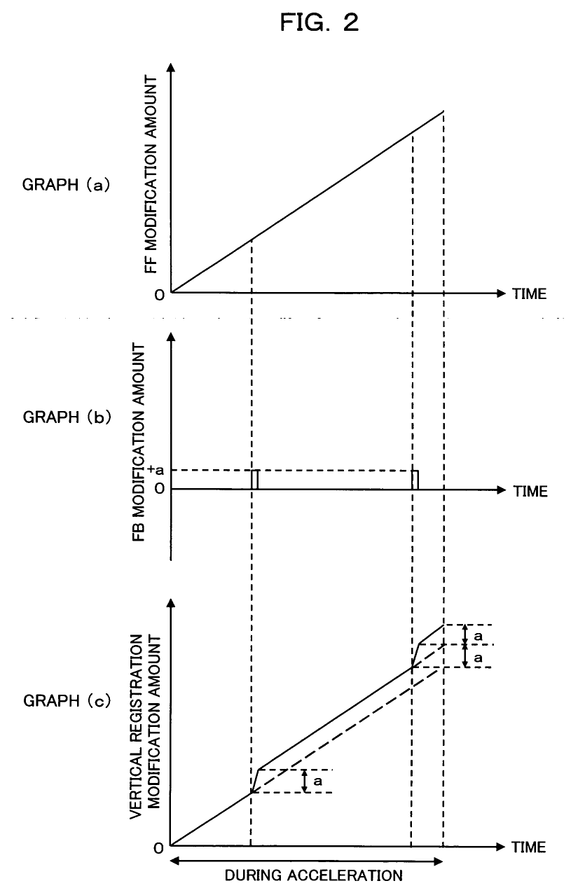

When data about a printing condition concerning the current printing (paper type, total image area ratio) is inputted via an input section 34, the predictive registration modification device 31 operates to search the database 32 using the inputted data about the printing condition as a search key, thereby selecting from among plural phase control coefficients stored in the database 32 a phase control coefficient that corresponds to the printing condition concerning the current printing. Specifically, the predictive registration modification device 31 selects a map (or mathematical formula) that corresponds to the inputted paper type, and refers to the selected map (or mathematical formula) for the inputted total image area ratio, thereby obtaining the phase control coefficient corresponding to the present printing condition. Then, according to the selected phase control coefficient, the predictive registration modification device 31 operates to output a registration modification signal (corresponding to the FF modification amount), as shown in graph (a) of FIG. 2, toward a non-illustrated phase control motor for controlling the phase of the plate cylinder 5 of each of the printing units 4A, 4B, 4D. Incidentally, the printing conditions (paper type, total image area ratio) can be either manually inputted by an operator or automatically inputted on-line from plate-making process, which is located upstream.

On the other hand, when any misregistration occurs in the vertical image registration of the images of the non-reference colors (black, cyan, yellow) with respect to the image of the reference color (magenta), the automatic image-registration device 11 outputs a pulsed registration modification signal (corresponding to the FB modification amount), as shown in graph (b) of FIG. 2, so as to compensate for the fluctuation in registration through feedback control. After the registration modification signal (FB modification amount) outputted from the automatic image-registration device 11 and the registration modification signal (FF modification amount) outputted from the predictive registration modification device 31 are added up by an adder 33 as shown in graph (c) of FIG. 2, the resultant signal is inputted to non-illustrated phase control motors as a control signal for controlling the phase of the plate cylinders 5 of each of the printing units 4A, 4B, 4D.

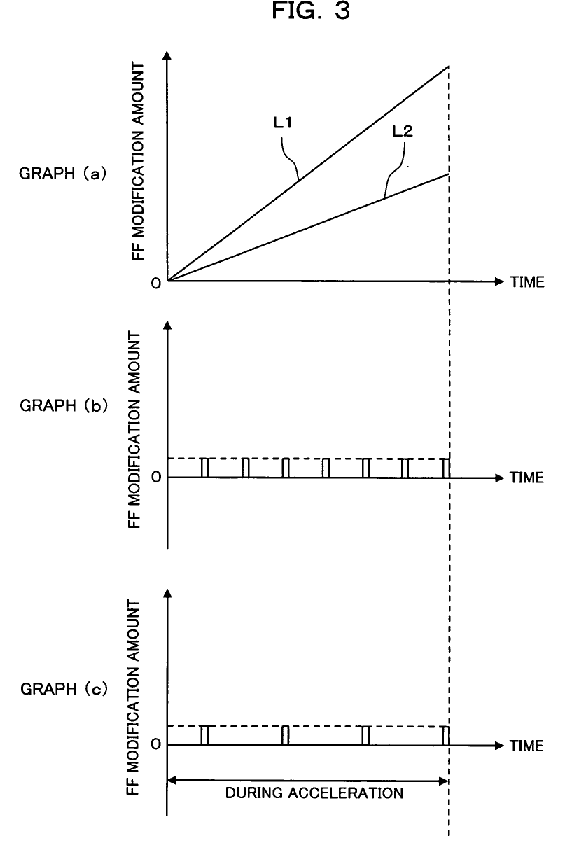

While FIG. 2 illustrates the case that the modification speed (registration modification speed) of the phase control motor is variable, FIG. 3 illustrates the registration modification signal outputted from the predictive registration modification device 31 when the registration modification speed of the phase control motor is constant. In FIG. 3, graph (a) shows the relation between the registration modification signal (corresponding to the FF modification amount) through feedforward control and acceleration time when registration modification speed is variable, wherein L1 and L2 each indicate different registration modification signals, which correspond to different phase control coefficients respectively. On the contrast, graph (b) and graph (c) of FIG. 3 each show the relations between the registration modification signal (corresponding to FF modification amount) through feedforward control and acceleration time when the modification speed is constant at L1 and L2 respectively, which L1 and L2 are indicated in graph (a) of FIG. 3. When the registration modification speed is constant as shown in graph (b) and graph (c) of FIG. 3, predictive modification is carried out intermittently, and the pulsed signal is outputted at shorter intervals as the phase control coefficient is larger. In the above-mentioned case, incidentally, when the registration modification signal from the automatic image-registration device 11 conflicts with the registration modification signal from the predictive registration modification device 31, it is possible to resolve the conflict by carrying out calculation in a similar manner as shown in FIG. 2 and adjusting the modification time appropriately.

Thus, during the acceleration from the adjustment speed toward the commercial-operation speed, the rotary printing machine according to the present embodiment operates to change the phase of the plate cylinder 5 of each printing unit 4A, 4B, 4D with respect to the reference printing unit 4C at a constant rate according to the printing condition (paper type, total image area ratio) in the direction that compensates for the fluctuation in vertical image registration. In addition, when the phase change of the plate cylinder 5 is not sufficient to keep pace with the fluctuation in registration due to the change of operating condition or the like, or when the phase change of the plate cylinder 5 is, on the contrast, so excessive that the registration deviates off in the reverse direction, the automatic image-registration device 11 modifies the phase of the plate cylinders 5 in the direction that compensates for the vertical image misregistration through feedback control.

With the rotary printing machine according to the present embodiment thus arranged, it is possible to suppress vertical image misregistration during the acceleration from the adjustment speed toward the commercial-operation speed, and to thereby ensure the quality required of acceptable sheets, as shown in FIG. 5, even for the printed sheets produced during the acceleration period from the adjustment speed toward the commercial-operation speed. As a consequence, with the rotary printing machine according to the present embodiment, it is possible to suppress the occurrence of broke due to the acceleration, thereby reducing production cost.

In the meantime, when the printing condition concerning the current printing is a new kind of condition and any appropriate data (phase control coefficient) hence does not exist in the database 32, the following procedure is carried out.

For example, when a paper web of an unknown paper type is used, the present procedure first selects a known paper type that is closest to the unknown paper type in their basis weight and other properties. Then, using the relation between the total image area ratio and the phase control coefficient for the selected known paper type, the procedure sets a phase control coefficient that corresponds to the total image area ratio concerning the current printing. Alternatively, since properties of the paper web differ greatly according to whether it has any coat layer or not, it is also preferable to classify the known paper types into two categories according to the presence or absence of a coat layer (coated paper or uncoated paper), and to select at least two known paper types from the category into which the subject unknown paper type falls. Then, using the relation between the total image area ratio and the phase control coefficient for each of the two or more known paper types thus selected, the procedure interpolatively calculates the phase control coefficient that corresponds to the total image area ratio concerning the current printing.

Subsequently, at a point in time just before the acceleration, the present procedure stores the value (average value) of a potentiometer of each phase control motor, and also stores the print speed (the rotational speed of the plate cylinder) or the average value of the print speed at that time. Then, during the acceleration from the adjustment speed toward the commercial-operation speed, the procedure outputs the registration modification signal according to the interpolatively calculated phase control coefficient toward the individual phase control motor, thereby changing the phase of each plate cylinder 5 at a constant rate in the direction that compensates for the fluctuation in vertical image registration. After the acceleration is completed, at a point in time when the registration fluctuation has reached a stable region (within a permissible range) through feedback control by the automatic image-registration device 11, the procedure again stores the value (average value) of the potentiometer of the individual phase control motor, and also stores the print speed (the rotational speed of the plate cylinder) or the average value of the print speed at that time. Lastly, using the potentiometer values, the print speeds, and the acceleration rate values at these points in time before and after the acceleration, the procedure calculates the change amount of potentiometer values per speed change time, and stores the calculated value in the database 32 as the phase control coefficient that corresponds to the current unknown printing condition. From the next time around, the data thus newly stored can be used as a phase control coefficient that corresponds to a similar printing condition.

It is also possible to calculate the phase control coefficient without using potentiometer values, based on misregistration of the register marks on the surface of the printed paper. Specifically, both the automatic registration control device 11 and the predictive registration modification device 31 are disabled (except for the part of the automatic registration control device 11 involved in detecting the misregistration amount of the register marks, which part is left enabled). Then, the register-mark detecting sensor 10 detects the register mark's positions for the individual color both at a point before the acceleration is started and at a point after the acceleration is completed. Based on the misregistration amount of the vertical positions of the non-reference-color register marks (black, cyan, yellow) with respect to the reference-color register mark (magenta), a phase control coefficient for each of the printing units 4A, 4B, 4D is calculated (it is also preferable to obtain the average value of the modification signal outputted from the register-mark detecting sensor 10 after the acceleration is completed and the print speed has reached a stable region). In this case, since the registration control is not carried out during the acceleration, the printed sheets produced during the acceleration are treated as broke.

Up to this point the first embodiment of the present invention having been described, it is to be noted that the registration control of the rotary printing machine according to the present invention is not limited to the present embodiment described above, but is also implementable in various forms without departing from the spirit of the present invention. For example, it is also preferable to suspend the feedback control by the automatic registration control device 11 during the acceleration, and to carry out the feedforward control by the predictive registration modification device 31 alone.

Further, the applications of the present invention are not limited to the registration control during the acceleration as the above-mentioned embodiment. In the case illustrated by FIG. 5, the registration control of the present invention is also applicable to the period during the deceleration from the print speed to the halt. In addition, the present invention is applicable not only to the case where the print speed is changed at a constant rate as shown in FIG. 5, but also to the case where the print speed is changed in a more complicated speed change pattern (speed change characteristic). Namely, as long as the print speed is changed in the same speed change pattern, even if the pattern is complicated, the registration will also fluctuate in the same pattern (registration fluctuation characteristic). Consequently, by setting the phase control characteristic for the plate cylinder of each printing unit based on the registration fluctuation pattern, it is possible to compensate for the vertical image misregistration between images printed by the individual printing units.

Better still, the rotary printing machines to which the present invention is applicable are not limited to the ones that have the arrangement of the above-mentioned embodiment. For example, it is also applicable to the rotary printing machines having more plural printing units, and to the rotary printing machine of the so-called shaftless type (individually-driven type), which has no main shaft but has a driving motor for each printing unit.

### (B) Second Embodiment

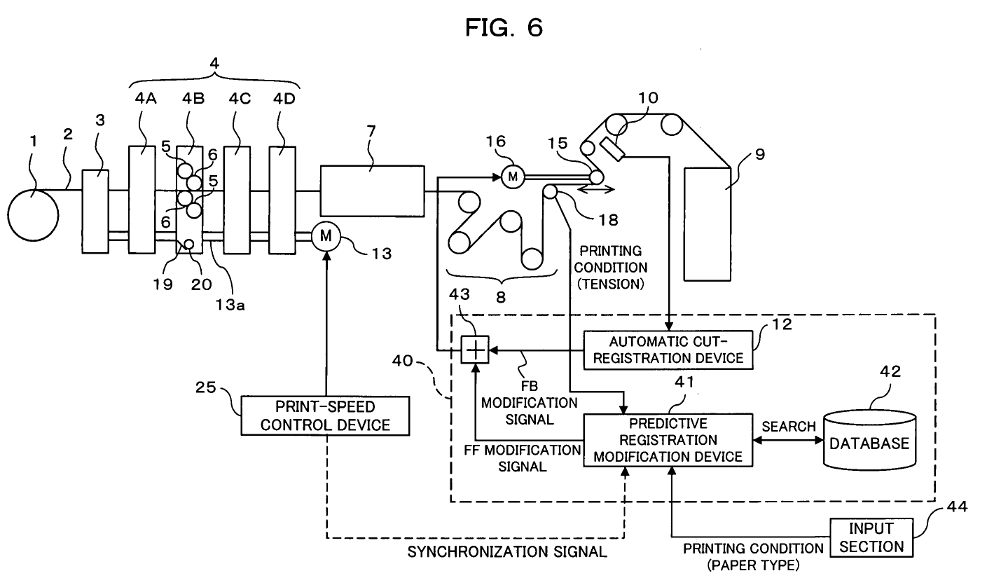

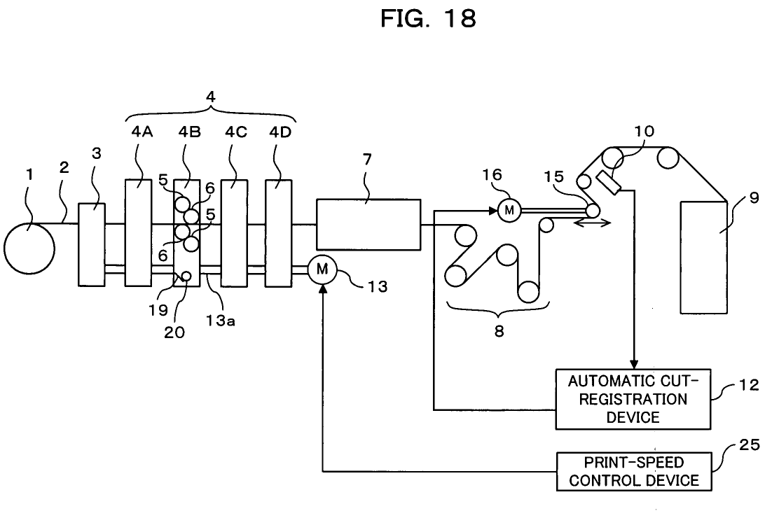

FIG. 6 is a schematic diagram showing the arrangement of a rotary printing machine according to the second embodiment of the present invention. As shown in FIG. 6, the rotary printing machine according to the present embodiment differs from the conventional rotary printing machine shown in FIG. 18 only in arrangement of the control device, being identical in arrangement of the main body of the printing machine. It is to be noted, however, that FIG. 6 is strictly for the purpose of simplifying the explanation of the nonessential part of the present invention, and does not signify that the registration control method according to the present invention is limitedly applied to the rotary printing machines with such arrangement.

The rotary printing machine according to the present embodiment has a predictive registration modification device (predictive cut-registration modification means) 41 in addition to the conventional automatic cut-registration device (automatic cut-registration modification means) 12, so that the automatic cut-registration device 12 and the predictive registration modification device 41 together compose a cut-registration control device 40. In contrast to the automatic cut-registration device 12, which modifies registration through feedback control, the predictive registration modification device 41 has the function of modifying registration through feedforward control.

The predictive registration modification device 41 carries out feedforward control specifically in the following manner. The feedforward control by the predictive registration modification device 41 is effected in response to a synchronization signal from the print-speed control device 25. The print-speed control device 25 controls the print speed through the control of the rotational speed of the main motor 13, operating as shown in FIG. 5: at the start of printing, it temporarily accelerates the print speed linearly toward an adjustment speed; at the completion of adjustment, it again accelerates the print speed from the adjustment speed toward a commercial-operation speed linearly, namely at a constant rate proportional to time; and at the completion of printing, it decelerates the print speed linearly from the commercial-operation speed toward the halt condition. In the present embodiment, a synchronization signal for starting the feedforward control is inputted from the print-speed control device 25 to the predictive registration modification device 41 at the start of the acceleration from the adjustment speed toward the commercial-operation speed, while a synchronization signal for stopping the feedforward control is inputted from the print-speed control device 25 to the predictive registration modification device 41 at the end of the acceleration.

The feedforward control by the predictive registration modification device 41 acts in such a manner as to compensate for the fluctuation of cut positions with respect to reference positions, namely, so as to compensate for the fluctuation in cut registration, by modifying the running length of the paper web 2 from the printing section (printing section) 4 toward the folding machine (cutting device) 9. Since the running length of the paper web 2 is adjustable in terms of the position of the compensator roll 15, the predictive registration modification device 41 controls the compensator driving motor 16 so as to adjust the position of the compensator roll 15, thereby modifying the running length of the paper web 2 from the printing section 4 toward the folding machine 9. In the present embodiment, the compensator roll 15 and the compensator driving motor 16 together compose the running-length modification means.

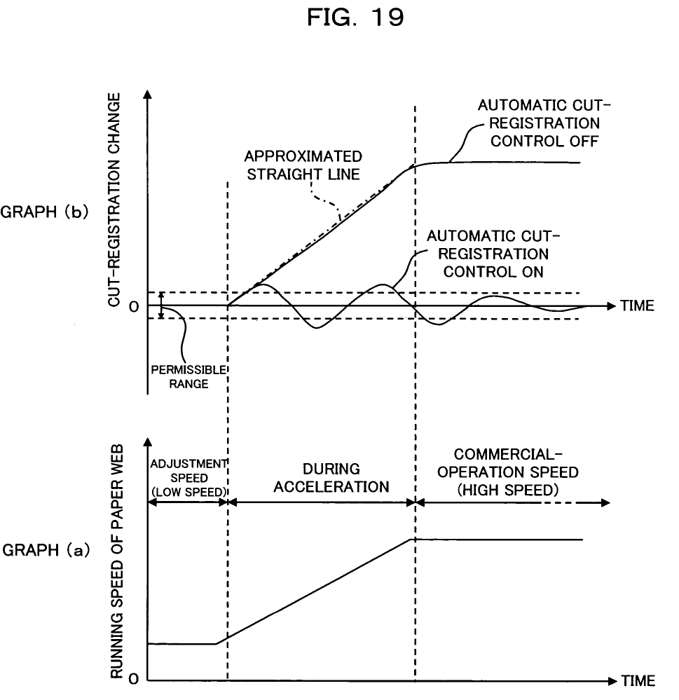

When the print speed is accelerated linearly as described above, the cut registration also changes linearly at a constant rate of change as shown in graph (b) of FIG. 19 (illustrating the case where the automatic cut-registration device 12 is disabled). In the present embodiment, the predictive registration modification device 41 therefore operates to change the running length of the paper web 2 linearly, namely at a constant rate proportional to time.

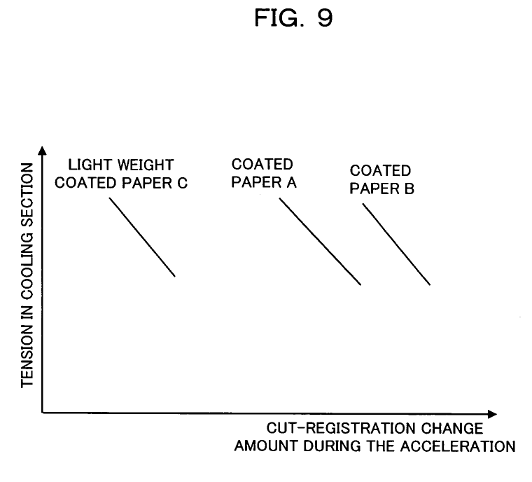

Meanwhile, through the conception process of the present invention, the inventors have found that even when the print speed is changed at the same rate of acceleration, the fluctuation characteristic of cut registration differs as each of certain particular printing conditions differs. Examples of such particular printing conditions are the type of paper of the paper web 2 and the tension that acts on the paper web 2 (the set tension during operation). It is considered that the fluctuation in cut registration is due to the fluctuation in the running length of the paper web during speed change, which fluctuation in the running length caused mainly by tension fluctuation. From this main cause, it is expected that the difference of paper types and the variation in preset tension have some effect. FIG. 9 shows the result of examining the relation between the tension that acts the paper web 2 and the fluctuation amount of cut registration in the cooling cylinder section 8 with respect to plural types of paper (coated paper A, coated paper B, light weight coated paper C). Incidentally, the tension that acts the paper web 2 can be detected by providing a sensor (tension detecting sensor) 18 to one of the guide rolls composing the cooling cylinder section 8, and by detecting the force applied from the paper web 2 to the guide roll by the sensor 18.

Since the fluctuation characteristic of cut registration thus differs as the paper type or the tension differs, in order to suppress fluctuation in cut registration in advance through feedforward control, it is necessary to adjust the control characteristic for the running length of the paper web 2 according to the paper type or the tension. On this account, in the present embodiment, the cut-registration control device 40 is equipped with a database 42 in which a running length control coefficient (running-length control characteristic) is stored for each of preset paper types and for each of preset tension values: the running length control coefficient means the gradient of the running length of the paper web 2 from the printing section 4 toward the folding machine 9 when the running length is changed in proportion to time (the rate of change in running length per time). More specifically, the relation between the tension value and the cut registration fluctuation can be expressed as a map (or mathematical formula) as shown in FIG. 9, so that the relation between the tension and the running length control coefficient can be also expressed as a map (or mathematical formula). In the database 42, the map (or mathematical formula) that expresses the relation between the tension value and the running length control coefficient is stored for each paper type.

When data about a printing condition concerning the current printing is inputted via the input section 44, or when the tension to the paper web 2 at the cooling cylinder section 8 is detected by the tension detection sensor 18, the predictive registration modification device 41 operates to search the database 42 using the inputted data as a search key, thereby selecting from among plural running length control coefficients stored in the database 42 the running length control coefficient that corresponds to the printing condition concerning the current printing. Then, according to the selected running length control coefficient, the predictive registration modification device 41 operates to output a cut-registration modification signal (corresponding to the FF modification amount), as shown in graph (a) of FIG. 7, toward the compensator driving motor 16. Incidentally, data about the paper type can be either manually inputted by an operator or automatically inputted on-line from plate-making process, which is located upstream. In addition, when the set value of the tension to the paper web 2 is known, it is preferable that the operator also manually inputs the value together with the paper type.

On the other hand, when any misregistration occurs in the cut registration, the automatic cut-registration modification device 12 outputs a pulsed cut-registration modification signal (corresponding to the FB modification amount), as shown in graph (b) of FIG. 7, so as to compensate for the fluctuation in cut registration through feedback control. After the cut-registration modification signal (FB modification amount) outputted from the automatic cut-registration modification device 12 and the cut-registration modification signal (FF modification amount) outputted from the predictive registration modification device 41 are added up by an adder 43 as shown in graph (c) of FIG. 7, the resultant signal is inputted to the compensator driving motor 16 as a control signal for changing the position of the compensator roll 15.

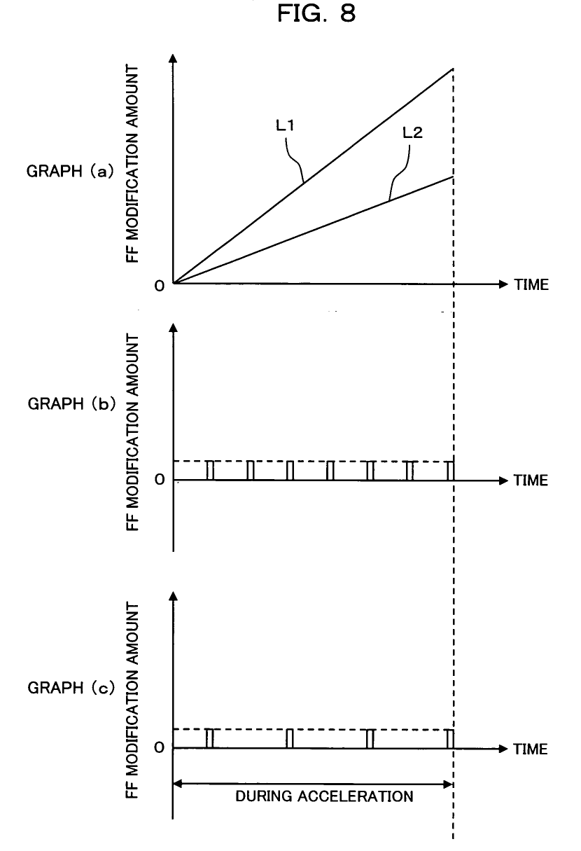

While FIG. 7 illustrates the case that the modification speed of the position of the compensator roll 15 (the change speed of path length) is variable, FIG. 8 illustrates the cut-registration modification signal outputted from the predictive registration modification device 41 when the modification speed of the position of the compensator roll 15 is constant. In FIG. 8, graph (a) shows the relation between the cut-registration modification signal (corresponding to FF modification amount) through feedforward control and acceleration time when the modification speed is variable, wherein L1, L2 each indicate different cut-registration modification signals, which correspond to different running length control coefficients respectively. On the contrast, graph (b) and graph (c) of FIG. 8 each show the relations between the cut-registration modification signal (corresponding to FF modification amount) through feedforward control and acceleration time when the modification speed is constant at L1 and L2, respectively, which L1 and L2 are illustrated in graph (a) of FIG. 8. When the modification speed is constant as shown in graph (b) and graph (c) of FIG. 8, predictive modification is carried out intermittently, and the pulsed signal is outputted at shorter intervals as the running length control coefficient is larger. In the above-mentioned case, incidentally, when the cut-registration-modification signal from the automatic cut-registration modification device 12 conflicts with the cut-registration modification signal from the predictive registration modification device 41, it is possible to resolve the conflict by carrying out calculation in a similar manner as shown in FIG. 7 and adjusting the modification time appropriately.

Thus, during the acceleration from the adjustment speed toward the commercial-operation speed, the rotary printing machine according to the present embodiment operates to change the running length of the paper web 2 from the printing section 4 toward the folding machine 9 at a constant rate according to printing conditions (the type of paper, the tension) in the direction that compensates for the fluctuation in cut registration. In addition, when the change in the running length of the paper web 2 is not sufficient to keep pace with the fluctuation in cut registration due to the change of operating condition or the like, or when the change in the running length of the paper web 2 is, on the contrast, so excessive that the cut-registration deviates off in the reverse direction, the automatic cut-registration modification device 12 modifies the position of the compensator roll 15 through feedback control s in the direction that compensates for the cut misregistration, thereby modifying the running length of the paper web 2.

With the rotary printing machine according to the present embodiment thus arranged, it is possible to suppress cut misregistration during the acceleration from the adjustment speed toward the commercial-operation speed, and to thereby ensure the quality required of acceptable sheets, as shown in FIG. 5, even for the printed sheets produced during the acceleration period from the adjustment speed toward the commercial-operation speed. As a consequence, with the rotary printing machine according to the present embodiment, it is possible to suppress the occurrence of broke due to the acceleration, thereby reducing production cost.

In the meantime, when the printing condition concerning the current printing is a new kind of condition and any appropriate data (running length control coefficient) hence does not exist in the database 42, the following procedure is carried out.

For example, when a paper web of an unknown paper type is used, the present procedure first selects a known paper type that is closest to the unknown paper type in their basis weight and other properties. Then, using the relation between the tension and the running length control coefficient for the selected known paper type, the procedure sets a running length control coefficient that corresponds to the tension concerning the current printing. Alternatively, since properties of the paper web differ greatly according to whether it has any coat layer or not, it is also preferable to classify the known paper types into two categories according to the presence or absence of a coat layer (coated paper or uncoated paper), and to select at least two known paper types from the category into which the subject unknown paper type falls. Then, using the relation between the tension and the running length control coefficient for each of the two or more known paper types thus selected, the procedure interpolatively calculates the running length control coefficient that corresponds to the tension concerning the current printing.

Subsequently, at a point in time just before the acceleration, the present procedure stores the value (average value) of a potentiometer of the compensator driving motor 16, and also stores the print speed (the rotational speed of the plate cylinder) or the average value of the print speed at that time. Then, during the acceleration from the adjustment speed toward the commercial-operation speed, the procedure outputs the cut-registration modification signal according to the interpolatively calculated running length control coefficient toward the compensator driving motor, thereby changing the running length at a constant rate in the direction that compensates for the fluctuation in cut registration attendant on the acceleration. After the acceleration is completed, at a point in time when the cut registration fluctuation has reached a stable region (within a permissible range) through feedback control by the automatic cut-registration device 12, the procedure again stores the value (average value) of the potentiometer of the compensator driving motor 16, and also stores the print speed (the rotational speed of the plate cylinder) or the average value of the print speed at that time. Lastly, using the potentiometer values, the print speeds, and the acceleration rate values at these points in time before and after the acceleration, the procedure calculates the change amount of potentiometer values per speed change time, and stores the calculated value in the database 42 as the running length control coefficient that corresponds to the current unknown printing condition. From the next time around, the data thus newly stored can be used as a running length control coefficient that corresponds to a similar printing condition.

It is also possible to calculate a running length control coefficient without using potentiometer values, based on misregistration of the cut register marks. Specifically, both the automatic cut-registration control device 12 and the predictive registration modification device 41 are disabled (except for the part of the automatic cut-registration control device 12 involved in detecting the misregistration amount of the register marks, which part is left enabled). Then, the register-mark detecting sensor 10 detects the cut register mark's position both at a point before the acceleration is started and at a point after the acceleration is completed. Based on the misregistration amounts of the vertical positions of cut register mark both at a point before the acceleration is started and at a point after the acceleration is completed, a running length control coefficient is calculated (it is also preferable to obtain the average value of the modification signal outputted from the register-mark detecting sensor 10 after the acceleration is completed and the print speed has reached a stable region). In this case, since the cut-registration control is not carried out during the acceleration, the printed sheets produced during the acceleration are treated as broke.

Up to this point the second embodiment of the present invention having been described, it is to be noted that the cut-registration control of the rotary printing machine according to the present invention is not limited to the present embodiment described above, but is also implementable in various forms without departing from the spirit of the present invention. For example, it is also preferable to suspend the feedback control by the automatic cut-registration control device 12 during the acceleration, and to carry out the feedforward control by the predictive registration modification device 41 alone.

Further, the applications of the present invention are not limited to the cut-registration control during the acceleration as the above-mentioned embodiment. In the case illustrated by FIG. 5, the cut-registration control of the present invention is also applicable to the period during the deceleration from the print speed to the halt. In addition, the present invention is applicable not only to the case where the print speed is changed at a constant rate as shown in FIG. 5, but also to the case where the print speed is changed in a more complicated speed change pattern (speed change characteristic). Namely, as long as the print speed is changed in the same speed change pattern, even if the pattern is complicated, the cut registration will fluctuate also in the same pattern (cut-registration fluctuation characteristic). Consequently, by setting the control characteristic for the running length of the paper web based on the cut-registration fluctuation pattern, it is possible to compensate for the cut misregistration attendant on the speed change.

Better still, the rotary printing machines to which the present invention is applicable are not limited to the ones that have the arrangement of the above-mentioned embodiment. For example, it is also applicable to the rotary printing machines having more plural printing units, and to the rotary printing machine of the so-called shaftless type (individually-driven type), which has no main shaft, but has a driving motor for the printing section and the folding machine individually.

Besides, while the running-length modification means is composed of the compensator driving motor and the compensator roll in the above-mentioned embodiment, it is also noted that the arrangement of the running-length modification means is not limited to the one described above, as long as capable of adjusting the running length of the paper web from the printing section (printing device) toward the folding machine (cutting device).

### (C) Third Embodiment

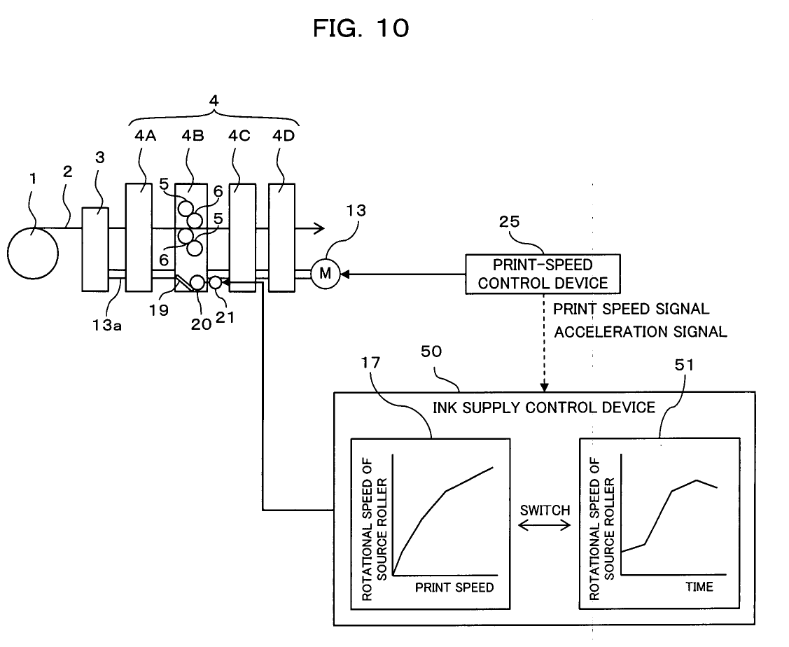

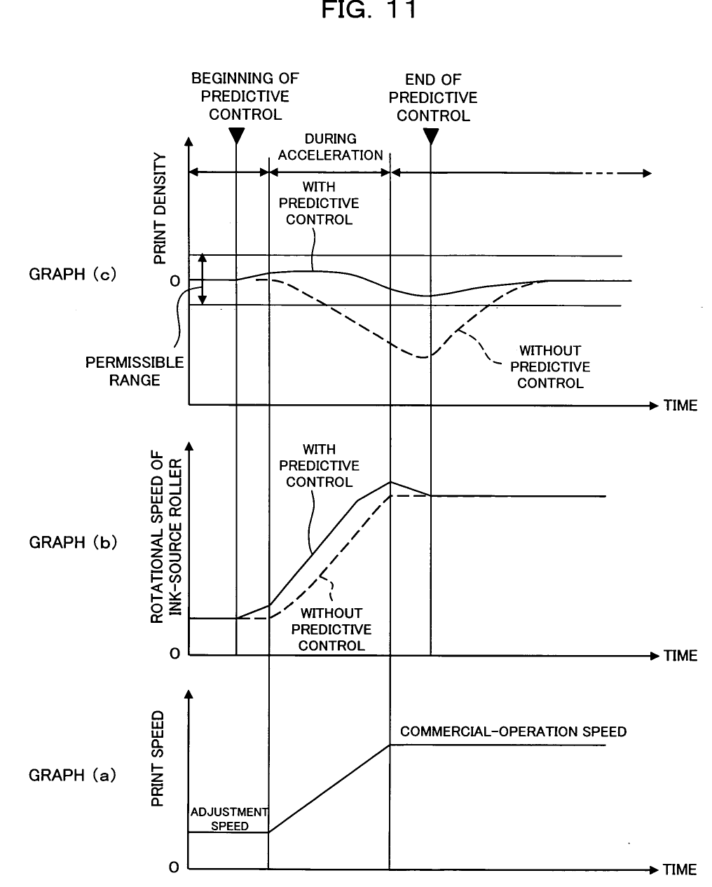

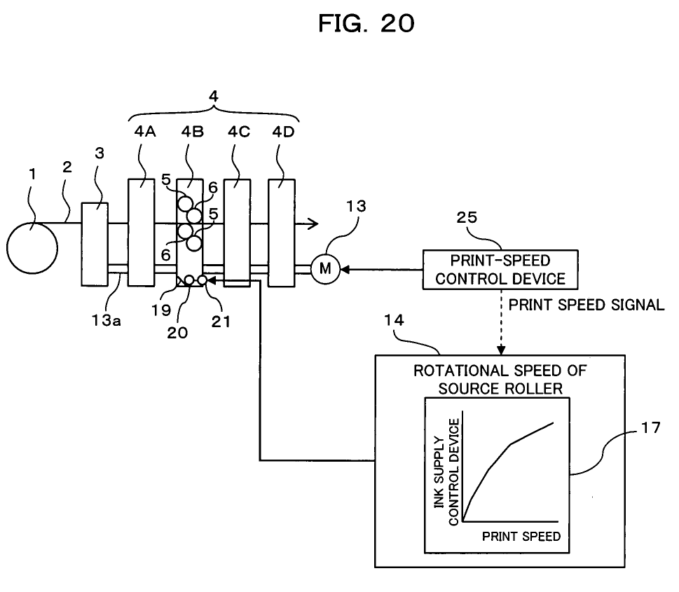

FIG. 10 is a schematic diagram showing the arrangement of a rotary printing machine according to the third embodiment of the present invention. As shown in FIG. 10, the rotary printing machine according to the present embodiment differs from the conventional rotary printing machine shown in FIG. 20 only in arrangement of the control device, being identical in arrangement of the main body of the printing machine. It is to be noted, however, that FIG. 10 is strictly for the purpose of simplifying the explanation of the nonessential part of the present invention, and does not signify that the print density control method according to the present invention is limitedly applied to the rotary printing machines with such arrangement. In FIG. 10, like components as in the conventional printing machine are designated by the same reference numerals.

The ink supply control device 50 of the rotary printing machine according to the present embodiment has a new speed function map 51 in addition to the conventional-speed function map (speed function map for the constant speed) 17. In contrast to the conventional-speed function map 17, on which the relation between the print speed and the rotational speed of the ink-source roller 20 (source roller rotational speed) is set, the new speed function map 51 is characterized by that the change of the rotational speed of the ink-source roller 20 per time is set thereon. The ink supply control device 50 selectively uses these two maps 17, 51 according to the details of the speed control by the print-speed control device 25. Specifically, when the print speed is a constant speed at the adjustment speed or the commercial-operation speed, the ink supply control device 50 controls the ink-source motor 21 according to the conventional-speed function map 17, thereby controlling the rotational speed of the ink-source roller 20 at a constant speed according to the print speed. On the other hand, during the acceleration from the adjustment speed to the commercial-operation speed, the ink supply control device 50 controls ink-source motor 21 according to the new speed function map 51, thereby adjusting the rotational speed of the ink-source roller 20 according to time. In the following, the conventional-speed function map 17 will be also called as a constant-speed-purpose speed function map, and the new speed function map 51 17 will be also called as an acceleration-purpose speed function map.

The following description will be made for a detailed explanation about the control of the rotational speed of the ink-source roller 20 by the ink supply control device 50 with reference to FIG. 11. In response to an acceleration signal from the print-speed control device 25, the ink supply control device 50 switches the control use map from the constant-speed-purpose speed function map 17 to the acceleration-purpose speed function map 51. The print-speed control device 25 controls the print speed through the control of the rotational speed of the main motor 13, operating as shown in graph (a) of FIG. 11: at the start of printing, it temporarily accelerates the print speed linearly toward an adjustment speed; at the completion of adjustment, it again accelerates the print speed from the adjustment speed toward a commercial-operation speed linearly, namely at a constant rate proportional to time; and at the completion of printing, it decelerates the print speed linearly from the commercial-operation speed toward the halt condition. In the present embodiment, the acceleration signal from the print-speed control device 25 is inputted to the ink supply control device 50 at a predetermined point in time before the acceleration is started (the starting point of predictive control shown in FIG. 11).

The print-speed control device 25, responsive to the acceleration signal, adjusts the rotational speed of the ink-source roller 20 according to the acceleration-purpose speed function map 51. The rotational speed control thus carried out according to the acceleration-purpose speed function map 51 serves as a predictive control, predicting the fluctuation in print density indicated by a broken line in graph (c) of FIG. 11 and adjusting the amount of ink supply so as to compensate for the print density fluctuation. The print-speed control device 25 hence starts accelerating the rotational speed of the ink-source roller 20 prior to the acceleration of the print speed, as shown in graph (b) of FIG. 11. The preceding time period by which the start of the predictive control precedes the start of the acceleration of the print speed is set with consideration given to the delay time since the amount of ink supply from the ink-source roller 20 starts changing until the print density starts changing. After the predictive control is started, the rotational speed of the ink-source roller 20 is set at a higher value as compared to the case of the conventional printing machine where the rotational speed of the ink-source roller 20 is controlled using the constant-speed-purpose speed function map 17 (the change in the rotational speed indicated by a broken line in graph (b) of FIG. 11). The rotational speed of the ink-source roller 20 is kept accelerated until after the acceleration of the print speed is completed, by the time it reaches a speed higher than the rotational speed corresponding to the commercial-operation speed. After the acceleration of the print speed is completed, the rotational speed of the ink-source roller 20 is gradually decelerated, and adjusted to the rotational speed corresponding to the commercial-operation speed at a predetermined point in time after the acceleration is completed. Thus, even after the acceleration of the print speed is completed, by keeping the print speed higher than the rotational speed at the commercial-operation speed for a while, it is possible to reduce the decline in print density, which occurs later than the acceleration of the print speed. After the rotational speed of the ink-source roller 20 has gradually decreased and reached the rotational speed at the commercial-operation speed, the predictive control is completed and the control use map is switched from the acceleration-purpose speed function map 51 to the constant-speed-purpose speed function map 17.

As described above, since the fluctuation in print density during the acceleration is predicted and the rotational speed of the ink-source roller 20 is adjusted accordingly, it becomes possible to settle the print density fluctuation during and after the acceleration within a permissible range as indicated by a solid line in graph (c) of FIG. 11. Consequently, with the printing machine according to the present embodiment, it is possible to ensure the quality required of acceptable sheets even for the printed sheets produced during the acceleration period from the adjustment speed to the commercial-operation speed as shown in FIG. 5. As a result, with the rotary printing machine according to the present embodiment, it is possible to reduce the occurrence of broke due to the acceleration, thereby reducing production cost.

### (D) Fourth Embodiment

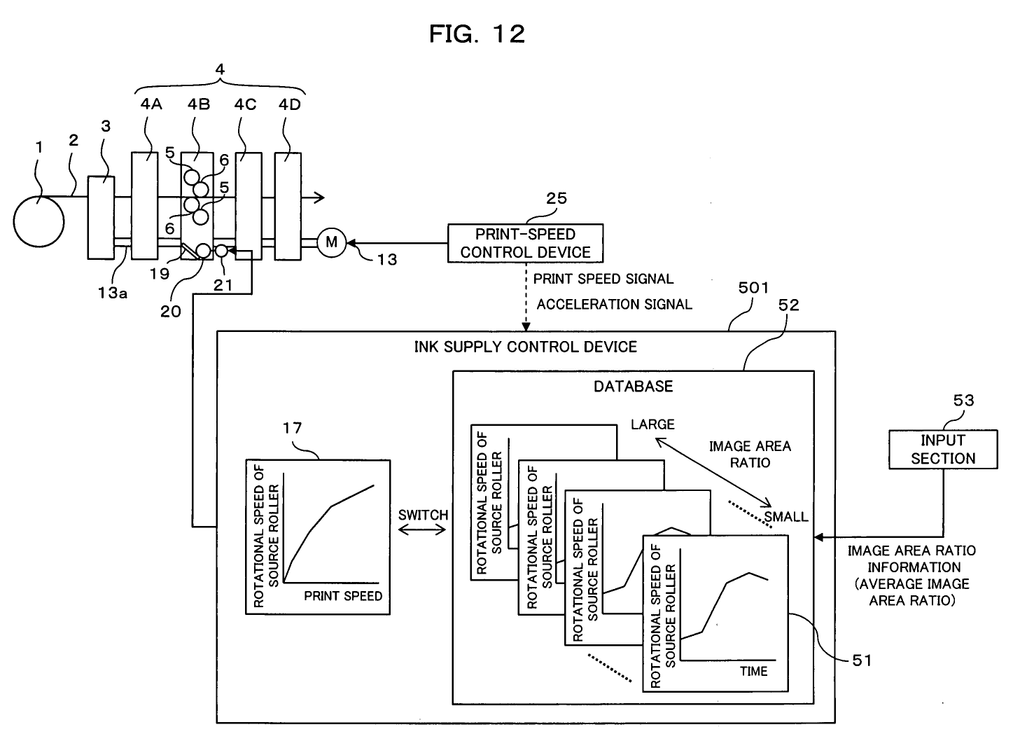

Next, the description will be made to the explanation of the fourth embodiment according to the present invention with reference to FIG. 12 to FIG. 14. In FIG. 12, like components as those in the first embodiment are designated by the same reference numerals.

The printing machine according to the present embodiment differs from the third embodiment in the function of the ink supply control device. Specifically, as shown in FIG. 12, the ink supply control device 501 according to the present embodiment has a database 52. In the database 52, plural acceleration-purpose speed function maps 51 are stored, each of which maps has control characteristics different to each other.

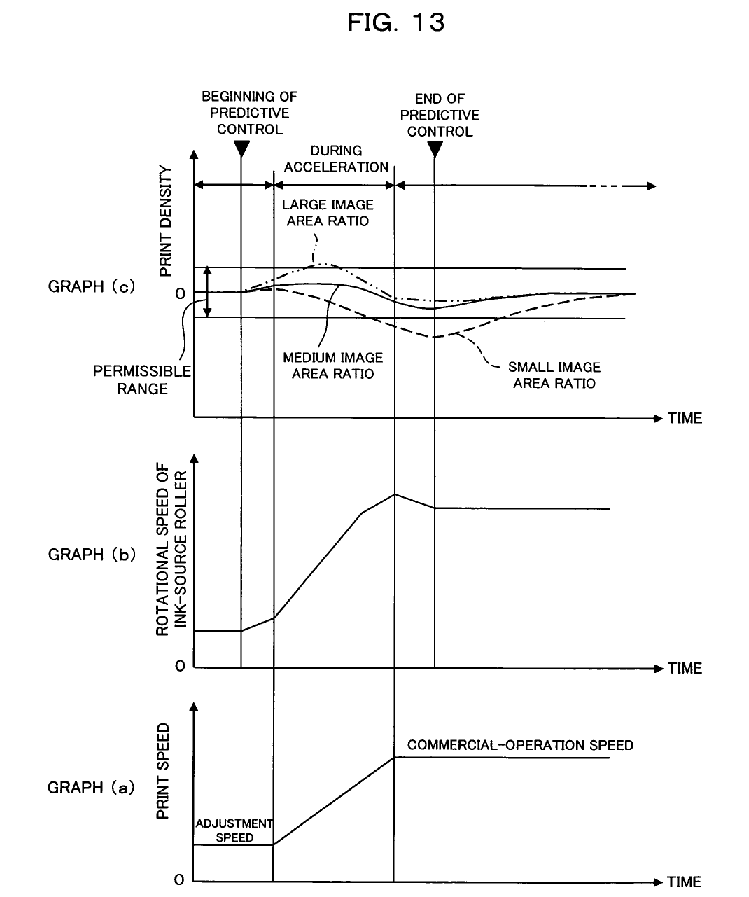

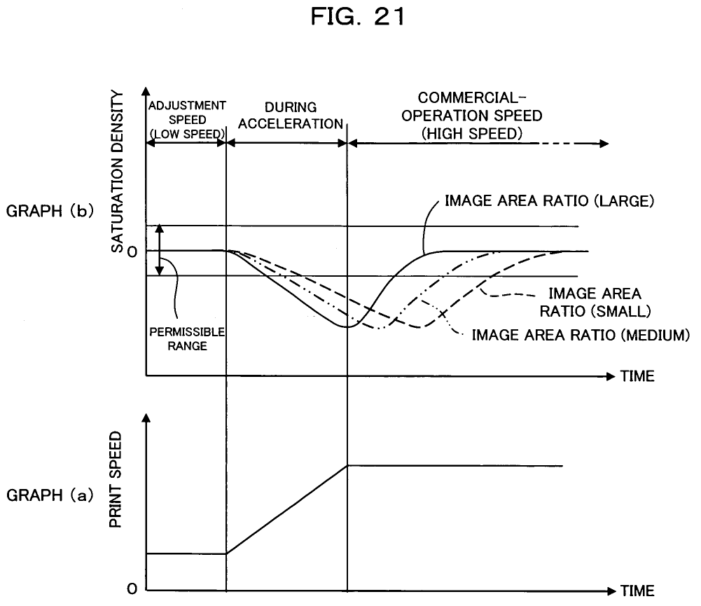

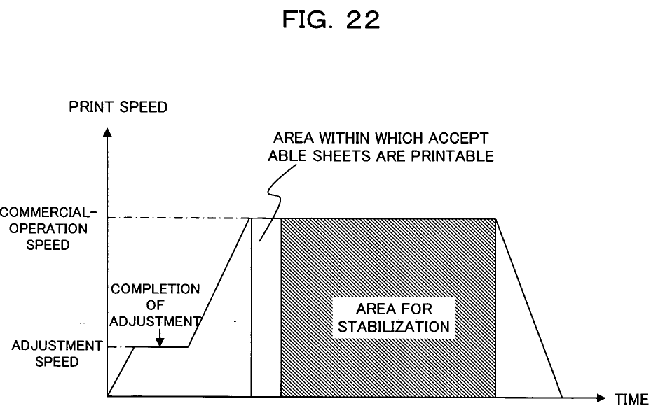

The acceleration-purpose speed function maps 51 stored in the database 52 are set each for different image area ratio values. This setting is determined with consideration given to the fact that, as shown in FIG. 21, the characteristic for the print density fluctuation attendant on the acceleration differs according to the image area ratio value of the image to be printed. To put it concretely, it is assumed that, for example, the acceleration-purpose speed function map 51 is generated for the control characteristic as shown in graph (b) of FIG. 13 according to the characteristic for the fluctuation in print density in the case where the image area ratio is at the middle value shown in FIG. 9. In this case, when the image area ratio value of the image concerning the current printing is equal to the assumed image area ratio value, it is possible to settle the print density fluctuation attendant on the acceleration reliably within a permissible range, as indicated by a solid line in graph (c) of FIG. 13. However, when the image area ratio value of the image concerning the current printing is larger or smaller than the assumed image area ratio value, a possibility arises that the print density fluctuation attendant on the acceleration falls outside a permissible range, as indicated by a chain double-dashed line and a broken line in graph (c) of FIG. 13, due to the inappropriate characteristic for the print density fluctuation. On this account, in the present embodiment, in order to suppress the print density fluctuation attendant on the acceleration more reliably, plural acceleration-purpose speed function maps 51 are prepared for different image area ratio values, so that it is possible to select an appropriate acceleration-purpose speed function map 51 according to the image area ratio value of the image concerning the current printing.

Meanwhile, although the image area ratio value is usually not uniform throughout the whole print surface but varies with the location therein, yet there are still few images whose image area ratio value ranges widely from 100% to 10% from location to location, and in most cases the image area ratio value usually stays within a certain measure of variation range. On this account, in the present embodiment, the average image area ratio for the whole print surface is practically used as the representative value of the image area ratio, and an appropriate acceleration-purpose speed function map 51 is selected from the database 52 according to the average image area ratio value of the image concerning the current printing. Data about the image area ratio required for calculating the average image area ratio value can be obtained from the plate-making process, either on-line or by way of a recording medium. When the data is inputted on-line, the input section 53, via which the image area ratio data is inputted, is implemented in a transmitting and receiving interface, while when the data is inputted by way of a recording medium, the input section 53 is implemented in a recording-medium read device. It is also preferable that the operator manually inputs the average image area ratio.

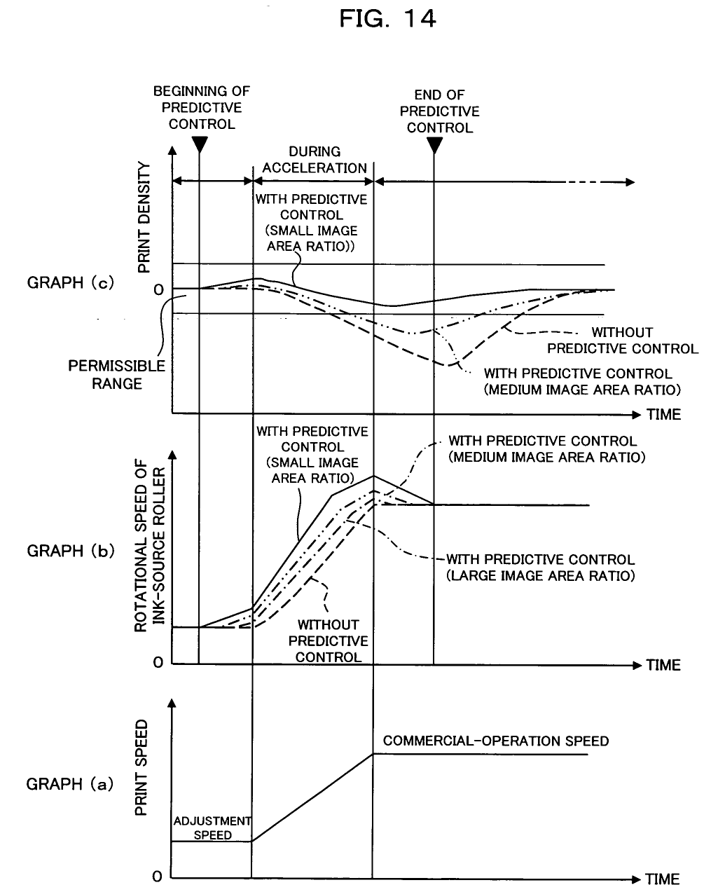

The control characteristic for the rotational speed of the ink-source roller 20 can be set as shown in graph (b) of FIG. 14 for each of the acceleration-purpose speed function maps 51 according to the image area ratio value. Graph (b) of FIG. 14 shows control characteristics of the rotational speed of the ink-source roller 20 respectively for three different value regions of high, middle, and low, into one of which regions the image area ratio value is classified, in comparison with the control characteristic (without predictive control) according to the conventional constant-speed-purpose speed function map 17. As shown in this graph, as the image area ratio value is lower, the rotational speed of the ink-source roller 20 is set at a higher value, and the point in time the predictive control starts is advanced with respect to the point in time the acceleration of the print speed starts with a longer advance time, while the point in time the predictive control ends is delayed with respect to the point in time the acceleration of the print speed ends with a longer delay time. These settings are resulted from the fact that as the image area ratio value is lower, the print density fluctuation delays with respect to the variation amount of ink supply with a longer delay time, and the variation amount of print density becomes relatively smaller with respect to the variation amount of ink supply.

Graph (c) of FIG. 14 illustrates, when the average image area ratio value of the image concerning the current printing is relatively small, a comparison of the print density variations for three different cases where the rotational speed of the ink-source roller 20 is changed using different control characteristics: the control characteristic when the image area ratio value is within the low region, which is indicated by a solid line in graph (b) of FIG. 14; the control characteristic when the image area ratio value is within the middle region, which is indicated by a chain double-dashed line; and the control characteristic according to the conventional constant-speed-purpose speed function map 17, which is indicated by a broken line. Thus, by changing the rotational speed of the ink-source roller 20 using an appropriate control characteristic according to the average image area ratio of the image concerning the current printing, it is possible to settle the print density fluctuation attendant on the acceleration within a permissible range more reliably.

### (E) Fifth Embodiment

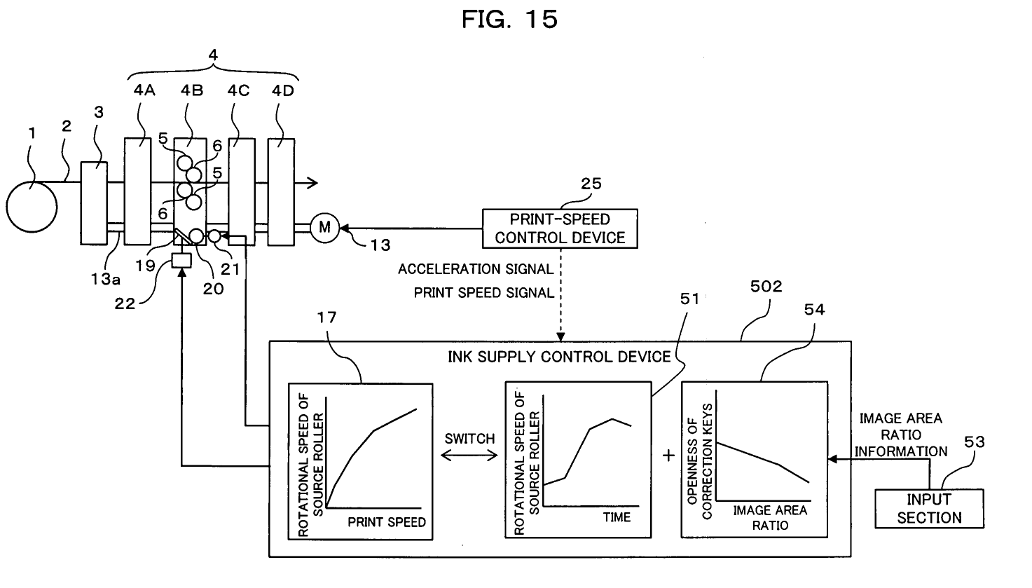

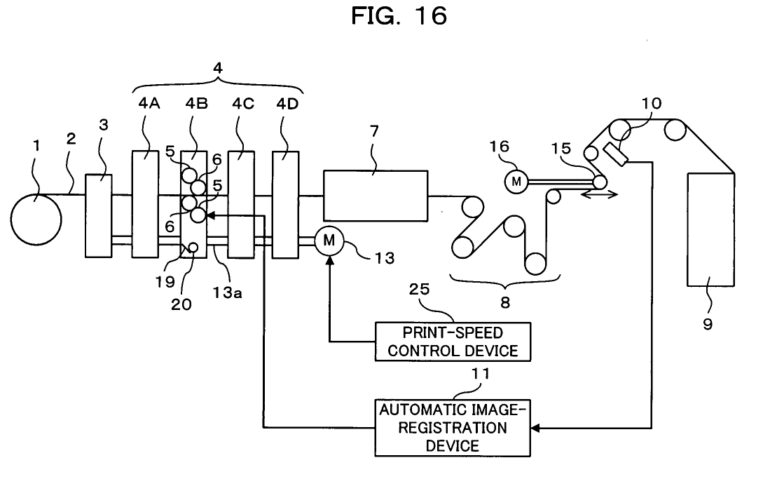

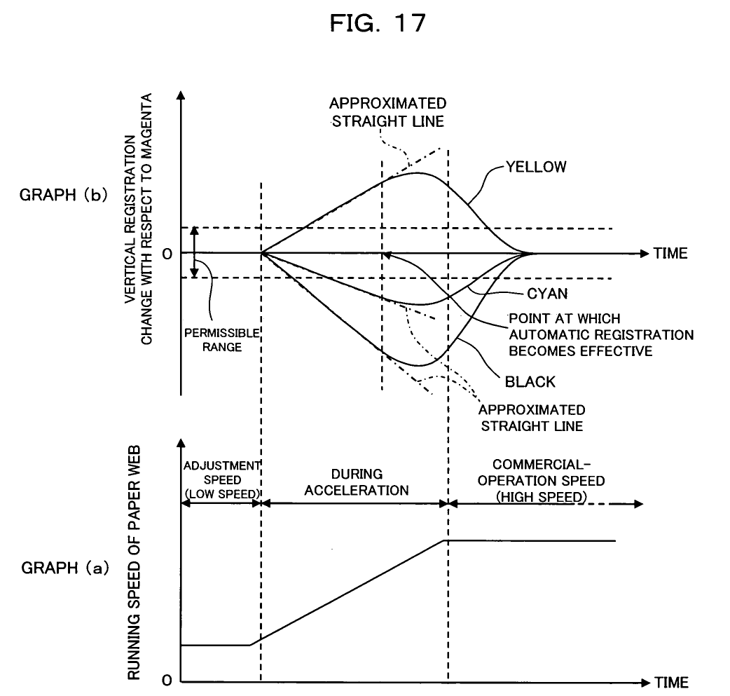

Last, the description will be made to the explanation of the fifth embodiment according to the present invention with reference to FIG. 15. In FIG. 15, like components as those in the third and fourth embodiments are designated by the same reference numerals.

The printing machine according to the present embodiment also differs from the first and second embodiments in the function of the ink supply control device. As described above, the print density fluctuation attendant on the acceleration characteristic differs according to the image area ratio value of the image to be printed. For that reason, in order to settle the print density fluctuation attendant on the acceleration within a permissible range, it is necessary to set the control characteristic for the amount of ink supply according to the image area ratio value. The second embodiment prepares plural acceleration-purpose speed function maps 51 for plural different value regions of the image area ratio, and sets a control characteristic of the rotational speed of the ink-source roller 20 for each of individual image area ratio values, thereby making it possible to supply ink using an appropriate ink-supply control characteristic according to the image area ratio value. On the other hand, the present embodiment keeps the control characteristic for the rotational speed of the ink-source roller 20 constant regardless of the image area ratio value, while adjusting the openness of the individual ink key 19 according to the image area ratio value, thereby making it possible to supply ink using an appropriate ink-supply control characteristic according to the image area ratio value.

Specifically, as shown in FIG. 15, the ink supply control device 502 according to the present embodiment stores a map for correcting the openness the ink keys 19 (key-openness correction map) 54 in addition to the acceleration-purpose speed function map 51, and has the function of controlling a key-openness adjusting device 22 to adjust the openness of the ink keys 19 according to the key-openness correction map 54. The acceleration-purpose speed function map 51 is set according to a reference image area ratio value predetermined. As the reference image area ratio value, a relatively large value (for example, 80-100%) is selected.

On the key-openness correction map 54, the correction amount of the openness of the ink keys (correction key-openness) with respect to the deviation of the image area ratio value of the image concerning the current printing from the reference image area ratio value is set. Upon starting the predictive control, the ink supply control device 502 compares the current image area ratio value with the reference image area ratio value in units of the widths of the ink keys 19, and controls the key-openness adjusting device 22 according to the deviation to correct the openness of the individual ink keys 19. In other words, the ink supply control device 502 corrects the openness of the individual ink keys 19 in proportion to the distribution of the image area rate. The correction of the openness of the individual ink keys 19 is continued during the period the predictive control is being carried out, and stopped when the predictive control is ended. Incidentally, in the key-openness correction map 54, the correction amount of the openness of the ink keys is set at a larger value as the current image area ratio value is smaller, reflecting the fact that as the image area ratio value is lower, the fluctuation in print density delays with respect to the variation in the amount of ink supply with a longer delay time, and the variation amount of print density becomes relatively smaller with respect to the variation amount of ink supply.

Thus, by correcting the openness of the individual ink keys 19 according to the image area ratio value in each of the widths of the ink keys, it is possible to supply ink using the appropriate ink-supply control characteristic according to the distribution of the image area rate along the width without the need of adjusting the control characteristic for the rotational speed of the ink-source roller 20 according to the image area ratio value. As a result, with the printing machine according to the present embodiment, it is possible to settle the print density fluctuation attendant on the acceleration within a permissible range, without being influenced by the image area ratio value. It is to be noted that, although being constant independently of time in the key-openness correction map 54 shown in FIG. 15, the correction key openness is variable according to the elapsed time since the predictive control started.

Up to this point the explanation of the third to fifth embodiments according to the present invention having been described, it is to be noted that the print density control of the rotary printing machine according to the present invention control is not limited to the above-mentioned embodiments, but is also implementable in various forms without departing from the spirit of the present invention. For example, an appropriate fluctuation characteristic of the print density during the acceleration differs according not only to the image area ratio value but also to the type of paper or the kind of ink, because the print density varies according to the type of paper or the kind of ink even when the ink amount is constant. On this account, it is also preferable to set different acceleration-purpose speed function maps (ink-supply control characteristic) for different types of paper or different kinds of ink and to store them in the database. During the acceleration, an appropriate acceleration-purpose speed function map is selected according to the type of paper or the kind of ink concerning the current printing from the database. Data about the type of paper or the kind of ink can be inputted to the ink supply control device either manually by an operator or automatically on-line from the plate-making process upstream.

In the particular case where the printing condition concerning the current printing (the paper type, the kind of ink) is a new kind of condition and any appropriate acceleration-purpose speed function map hence does not exist in the database, the following procedure is carried out. For example, when a paper web of an unknown paper type is used, the procedure first selects from the known paper types the one closest to the unknown paper type in their basis weight and other properties. Next, the procedure controls the rotational speed of the ink-source roller using the acceleration-purpose speed function map of the known paper type. Alternatively, since properties of the paper web differ greatly according to whether it has any coat layer or not, it is also preferable to classify the known paper types into two categories according to the presence or absence of a coat layer (coated paper or uncoated paper), and to select at least two known paper types from the category into which the unknown type of paper falls. Then, using the acceleration-purpose speed function maps of the selected at least two known paper types, the procedure interpolatively calculates the acceleration-purpose speed function map according to the paper type concerning the current printing.

It is also to be noted that the application of the present invention is not limited to the print density control during the acceleration as the above-mentioned embodiment. In the case shown in FIG. 5, the print density control of the present invention is also available during the deceleration from the print speed to the halt. In addition, it is also applicable not only to the case where the print speed is changed at a constant rate of change as shown in FIG. 5, but also to the case where the print speed is changed at a more complicated pattern (speed change characteristic). Namely, as long as the speed changes are carried out in the same speed change pattern, even if the pattern is complicated, the print density will change also in the same pattern (print-density fluctuation characteristic). Consequently, by setting the ink-supply control characteristic based on the print density change pattern, it is possible to reduce the print density fluctuation attendant on the change of print speed.

Better still, the rotary printing machines to which the present invention is applicable are not limited to the ones that have the arrangement of the above-mentioned embodiments. Specifically, it is applicable not only to the rotary printing machine of the shaft-driven type as shown in the embodiments, but also to the rotary printing machine of the so-called shaftless type (individually-driven type), which has no main shaft but has a driving motor for each printing unit. Likewise, the print-density control method of the present invention is also effective when applied to the sheet-fed-type printing machine. Since plural rollers intervene in the path from the ink-source roller toward the surface of the plate also in the sheet-fed printing machine, there is a possibility that the fluctuation in print density occurs during the change of the print speed, due to the delayed change in the amount of ink supplied to the plate surface. On this account, by applying the print-density control method of the present invention, it is possible to reduce the print density fluctuation attendant on the change in print speed, thereby making it possible to reduce broke.

The same goes for the arrangement of the ink supplying device: the rotary printing machines to which the present invention is applicable are not limited to the ones that have the ink-source roller and the ink keys as the above-mentioned embodiments. Namely, the arrangement of the ink supplying device is not particularly limited as long as plural ink rollers intervene between the ink supplying device and the plate cylinder, and the present invention is also applicable to, for example, the printing machine having an ink rail as the ink supplying device.

What is claimed is:

1. A rotary printing machine comprising:
a plurality of printing units each for making printing in the same area on a paper web;
print-speed control means for changing print speed from a first speed to a second speed, which is different from the first speed, according to a predetermined speed-change characteristic;
storage means in which a phase control characteristic is stored, said phase control characteristic being a characteristic of phase control between plate cylinders of said printing units preliminary set so as to compensate for misregistration between printed images of the printing units based on a registration fluctuation characteristic, which is a predictive characteristic of fluctuation in registration between the printed images of the printing units in the case where the print speed is changed according to the speed change characteristic; and
predictive registration modification means for modifying phase relation between the plate cylinders of said printing units according to the phase control characteristic stored in said storage means while the print speed is being changed by said print-speed control means.

2. A rotary printing machine comprising:
a plurality of printing units each for making printing in the same area on a paper web;
print-speed control means for changing print speed from a first speed to a second speed, which is different from the first speed, according to a predetermined speed change characteristic;
a database in which a phase control characteristic is stored, said phase control characteristic being a characteristic preliminary set for phase control between plate cylinders of said printing units so as to compensate for misregistration between printed images of said printing units based on a registration fluctuation characteristic, which is a predictive characteristic of fluctuation in registration between the printed images of said printing units, for each of particular printing conditions that affect the registration fluctuation characteristic, in the case where the print speed is changed according to the speed change characteristic;
input means via which printing conditions concerning the current printing is inputted; and
predictive registration modification means for selecting from among a plurality of phase control characteristics stored in said database an appropriate phase control characteristic according to the printing conditions inputted via said input means, and for modifying phase relation of the plate cylinders between said printing units according to the selected phase control characteristic while the print speed is being changed by said print-speed control means.

3. A rotary printing machine as defined in claim 1 or 2, further comprising automatic registration modification means for detecting misregistration between images printed by said printing units, and for automatically modifying the phase relation so as to compensate for the detected misregistration.

4. A rotary printing machine comprising:
a printing device for printing images on a running continuous paper web at regular intervals;
a cutting device for cutting the paper web into predetermined areas including the individual images, respectively, at a speed synchronized with the print speed;
print-speed control means for changing print speed from a first speed to a second speed, which is different from the first speed, according to a predetermined speed change characteristic;
running-length modification means for modifying a running length of the paper web from said printing section to said cutting device;
storage means in which a running-length control characteristic is stored, said running-length control characteristic being a characteristic preliminary set for control of the running length so as to compensate for cut misregistration of said cutting device based on a cut-registration fluctuation characteristic, which is a predictive fluctuation characteristic of cut registration of a cutting position by said cutting device with respect to a reference position in the case where the print speed is changed according to the speed change characteristic; and
predictive cut-registration modification means for modifying the running length by controlling said running-length modification means according to the running-length control characteristic stored in said storage means while the print speed is being changed by said print-speed control means.

5. A rotary printing machine comprising:
a printing device for printing images on a running continuous paper web at regular intervals;
a cutting device for cutting the paper web into predetermined areas including the individual images, respectively, at a speed synchronized with the print speed;
print-speed control means for changing print speed from a first speed to a second speed, which is different from the first speed, according to a predetermined speed change characteristic;
running-length modification means for modifying a running length of the paper web from said printing section to said cutting device;
a database in which a running-length control characteristic is stored, said running-length control characteristic being a characteristic preliminary set for control of the running length so as to compensate for cut misregistration of said cutting device based on a cut-registration fluctuation characteristic, which is a predictive fluctuation characteristic of cut registration of a cutting position by said cutting device with respect to a reference position, for each of particular printing conditions that affect the registration fluctuation characteristic, in the case where the print speed is changed according to the speed change characteristic;
input means via which printing conditions concerning the current printing is inputted; and
predictive cut-registration modification means for selecting from among a plurality of running-length control characteristics stored in said database one running-length control characteristic based on the printing conditions inputted via said input means, and for modifying the running length by controlling said running-length modification means according to the selected running-length control characteristic while the print speed is being changed by said print-speed control means.

6. A rotary printing machine as defined in claim 4 or 5, further comprising automatic cut-registration modification means for detecting cut misregistration of a cutting position by said cutting device with respect to a reference position, and for automatically modifying the running length by so as to compensate for the detected misregistration by controlling said running-length modification means.

7. A printing machine comprising:
an ink supplying device for supplying ink;
a plurality of ink rollers for transferring the ink sequentially from said ink supplying device to a plate cylinder;
print-speed control means for changing print speed from a first speed to a second speed, which is different from the first speed, according to a predetermined speed change characteristic;
storage means in which an ink-supply control characteristic is stored, said ink-supply control characteristic being a characteristic preliminary set for control of ink supply from said ink supplying device so as to compensate for variation in print density based on a print-density variation characteristic, which is a predictive characteristic of variation in print density in the case where the print speed is changed according to the speed change characteristic; and
ink-supply control means for controlling an amount of ink supply from said ink supplying device;
said ink-supply control means being operable to control the amount of ink supplied from said ink supplying device according to the print speed during the constant-speed operation, and to adjust the amount of ink supplied from said ink supplying device according to the ink-supply control characteristic stored in said storage means during a predetermined period between a instant before said print-speed control means starts changing of the print speed and another instant after the changing of the print speed ends.

8. A printing machine comprising:
an ink bottle containing ink;
an ink-source roller, incorporated in said ink bottle, for controlling an amount of ink supply from said ink bottle in terms of the rotational speed;
a plurality of ink keys, incorporated in said ink bottle together with said ink-source roller and arranged axially of said ink-source roller, for controlling the amount of ink supplied from said ink bottle in terms of the openness of a gap with respect to said ink-source roller;
a plurality of ink rollers for transferring ink sequentially from said ink-source roller to a plate cylinder;
print-speed control means for changing print speed from a first speed to a second speed, which is different from the first-speed, according to a predetermined speed change characteristic;
storage means in which a rotational-speed control characteristic is stored, said rotational-speed control characteristic being a characteristic preliminary set for control of the rotation speed of said ink-source roller with respected to time so as to compensate for the variation in print density based on a print-density variation characteristic, which is a predictive characteristic of the variation in print density in the case where the print speed is changed according to the speed change characteristic; and
rotational-speed control means for controlling the rotational speed of said ink-source roller;
said rotational-speed control means being operable to control the rotational speed of said ink-source roller according to the print speed during constant-speed operation, and to adjust the rotational speed of said ink-source roller according to the rotational-speed control characteristic stored in said storage means during a predetermined period between a instant before said print-speed control means starts changing of the print speed and another instant after the changing of the print speed ends.

9. A printing machine as defined in claim 8, wherein said storage means is a database in which the rotational-speed control characteristic is stored for each image area ratio, said rotational-speed control characteristic being preliminary set based on a print-density variation characteristic predicted for each image area ratio;
said rotational-speed control means being operable, during the predetermined period, to select from among a plurality of rotational-speed control characteristics stored in said database one rotational-speed control characteristic according to a mean image area ratio of the printed product of the current printing, and to adjust the rotational speed of said ink-source roller according to the selected rotational-speed control characteristic.

10. A printing machine as defined in claim 8, further comprising openness control means for controlling the openness of said ink keys;
said storage means storing the rotational-speed control characteristic, which is a characteristic set for control of the rotational speed of said ink-source roller with respect to time in the case where the image area rate is equal to a predetermined reference image area rate, and the openness control characteristic, which is a characteristic set for control of openness of the ink keys with respect to deviation of the image area rate from the reference image area rate, said rotational-speed control characteristic and said openness control characteristic being set based on the print-density variation characteristic predicted for each image area ratio;
said rotational-speed control means being operable to adjust the rotational speed of said ink-source roller according to the rotational-speed control characteristic stored in said storage means during the predetermined period;
said openness control means being operable to modify openness of each of said ink keys according to the openness control characteristic stored in said storage means in proportion to distribution of the image area rate along a width of the printed product of the current printing during the predetermined period.
